(19) United States
(12) Patent Application Publication
(10) Pub. No.: US 2018/0090987 A1
(43) Pub. Date: Mar. 29, 2018

(54) CONTROL DEVICE, APPARATUS CONTROL DEVICE, CONTROL SYSTEM, CONTROL METHOD AND PROGRAM

(71) Applicant: NEC CORPORATION, Tokyo (JP)

(72) Inventor: Ryo HASHIMOTO, Tokyo (JP)

(21) Appl. No.: 15/563,142

(22) PCT Filed: Mar. 29, 2016
(86) PCT No.: PCT/JP2016/060017

§ 371 Date: Sep. 29, 2017

(30) Foreign Application Priority Data
Mar. 30, 2015 (JP) 2015-068857

(51) Int. Cl. H02J 13/00; H02J 3/38; G05B 15/02

(52) U.S. Cl. CPC H02J 13/0013; G05B 15/02; H02J 3/386; H02J 3/383

(57) ABSTRACT

A control device is provided with: a setting unit that at the time of receiving status information relating to a plurality of power supply/demand adjustment devices, sets operation control information of each of the plurality of power supply/demand adjustment devices on the basis of the status information; and a transmission unit that transmits the operation control information to corresponding power supply/demand adjustment devices.

### TECHNICAL FIELD

The present invention relates to a control device, an apparatus control device, a control system, a control method, and a program for controlling a power supply/demand adjustment device.

### BACKGROUND ART

A method of using a power supply/demand adjustment device such as a storage battery is known as a method of carrying out power supply/demand adjustment

Patent Document 1 discloses a power system control system that performs power supply/demand adjustment rising a plurality of storage batteries.

In the power system control system described in Patent Document 1, a hierarchical supply/demand control device receives information of storage batteries (for example, charging efficiency or residual capacity) from each of a plurality of (subordinate) storage batteries that are under its control.

The hierarchical supply/demand control device consolidates the information of each storage battery that is under its control.

The hierarchical supply/demand control device transmits the consolidated storage battery information that is the information of the storage batteries that was consolidated to a higher-order device, and then receives control information that relates to the consolidated storage batteries from the higher-order device.

The hierarchical supply/demand control device generates control information of each storage battery under its control on the basis of the received control information and the information of each storage battery under its control.

The hierarchical supply/demand control device uses the control information of each storage battery under its control to control the charging/discharging of each storage battery under its control.

### LITERATURE OF THE PRIOR ART

### Patent Documents

Patent Document 1: JP 5460622 B

### SUMMARY

### Problem to be Solved by the Invention

In the power system control system described in Patent Document 1, a method is considered in which, for example, the hierarchical supply/demand control device updates the consolidated storage battery information that relates to all storage batteries under its control for each fixed time interval and transmits the consolidated storage battery information that follows updating to the higher-order device.

In this case, the hierarchical supply/demand control device, when unable to receive information of all storage batteries under its control within a fixed time interval, becomes unable to generate new consolidated storage battery information that relates to all of these storage batteries that are under its control. The consolidated storage battery information is used when generating control information for controlling the storage batteries. The problem therefore arises that when new consolidated storage battery information cannot be generated, the storage batteries under its control cannot be used to perform power supply/demand adjustment with good accuracy. This problem is not limited to cases in which the power supply/demand adjustment devices are storage batteries and may also arise when the power supply/demand adjustment devices are devices other than storage batteries (such as power generation devices, electrical equipment, and electric vehicles).

It is an object of the present invention to provide a control device, an apparatus control device, a control system, a control method, and a program that can solve the above-described problem.

### Means for Solving the Problem

The control device of the present invention is provided with: a setting unit that, at the time of receiving status information that relates to a plurality of power supply/demand adjustment devices, sets operation control information of each of the plurality of power supply/demand adjustment devices on the basis of the status information; and

a transmission unit that transmits the operation control information to the corresponding power supply/demand adjustment devices.

The apparatus control device of the present invention is an apparatus control device that controls the operation of a supply/demand adjustment device that is connected to a power system and includes:

detection means that detects a state of the supply/demand adjustment device; communication means that transmits the detection result of the detection means to an outside device and that receives from the outside device operation control information that controls the operation of the supply/demand adjustment device; and

control means that replaces operation control information that is being held with operation control information that was received by the communication means and, on the basis of the operation control information that follows replacement, controls the operation of the supply/demand adjustment device.

The control system of the present invention includes a first control device that controls the operation of a power supply/demand adjustment device that is connected to a power system and a second control device that communicates with the first control device, wherein:

the first control device includes:

a detection unit that detects a state relating to the power supply/demand adjustment device;

a communication unit that transmits status information, that indicates the state relating to the power supply/demand adjustment device that was detected by the detection unit, to the second control device and that receives from the second control device operation control information that controls the operation of the power supply/demand adjustment device; and

a control unit that replaces operation control information that is being held with operation control information that was received by the communication unit and that controls the operation of the power supply/demand adjustment device on the basis of the operation control information; and

the second control device includes:

a setting unit that sets operation control information of each of the plurality of power supply/demand adjustment devices on the basis of the status information at the time of receiving status information that relates to the plurality of power supply/demand adjustment devices, and

a transmission unit that transmits the operation control information to the corresponding power supply/demand adjustment devices.

The control method of the present invention is a method that includes steps of:

at the time of receiving status information that relates to a plurality of power supply/demand adjustment devices, setting operation control information of each of the plurality of power supply/demand adjustment devices on the basis of the status information; and

transmitting the operation control information to the corresponding power supply/demand adjustment devices.

Alternatively, the control method of the present invention includes steps of

detecting a state of supply/demand adjustment devices that are connected to a power system;

transmitting the detection result of the detection means to an outside device and receiving from the outside device operation control information that controls the operation of the supply/demand adjustment devices; and

replacing operation control information that is being held with operation control information that was received and controlling the operation of the supply/demand adjustment devices on the basis of the operation control information that follows replacement.

The program of the present invention is a program for causing a computer to execute:

a setting procedure of at the time of receiving status information that relates to a plurality of power supply/demand adjustment devices, setting operation control information of each of the plurality of power supply/demand adjustment devices on the basis of the status information; and

a transmission procedure of transmitting the operation control information to the corresponding power supply/demand adjustment devices.

Alternatively, the program of the present invention is a program for causing a computer to execute:

a detection procedure of detecting a state of a supply/demand adjustment device that is connected to a power system;

a communication procedure of transmitting the detection result of the detection means to an outside device and receiving from the outside device operation control information that controls the operation of the supply/demand adjustment device; and

a control procedure of replacing operation control information that is being held with operation control information that was received and controlling the operation of the supply/demand adjustment device on the basis of the operation control information that follows replacement.

### Effect of the Invention

The present invention enables the use of a plurality of power supply/demand adjustment devices to execute power supply/demand adjustment with good accuracy.

### BRIEF DESCRIPTION OF THE DRAWINGS

### [FIG. 1]

FIG. 1 shows control device A of the first exemplary embodiment of the present invention.

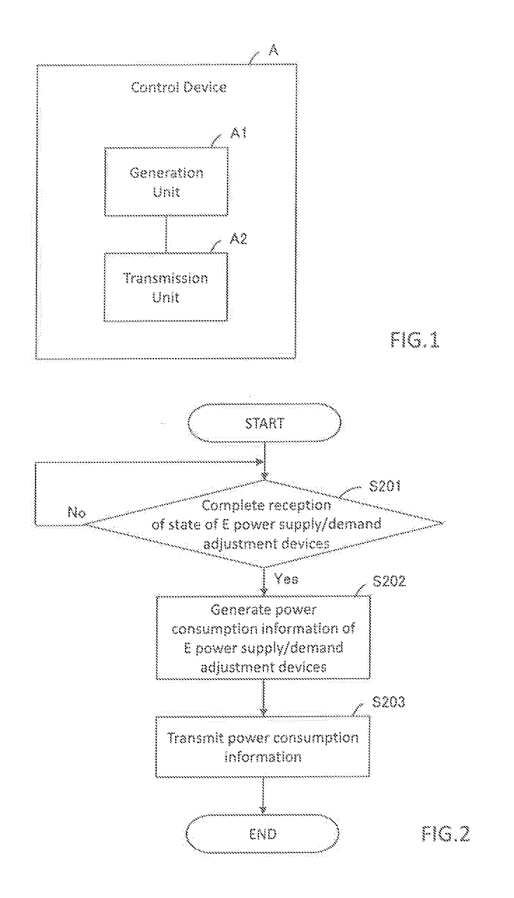

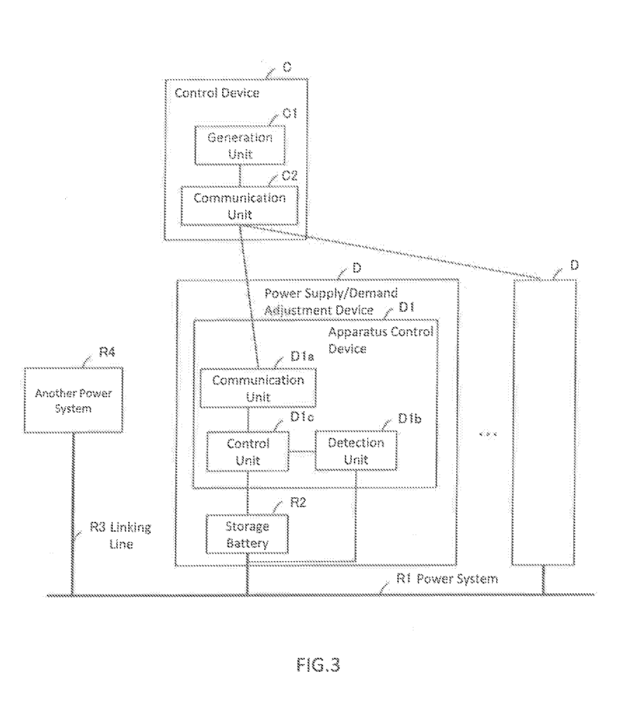

### [FIG. 2]

FIG. 2 is a flow chart for describing the operation of control device A.

### [FIG. 3]

FIG. 3 shows control device C of the second exemplary embodiment of the present invention.

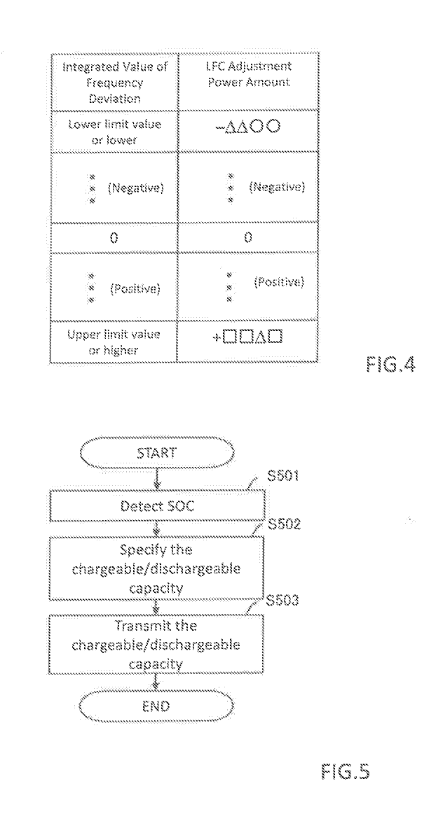

### [FIG. 4]

FIG. 4 shows an example of operation control information.

### [FIG. 5]

FIG. 5 is a How chart for describing the transmission operation of power supply/demand adjustment device D.

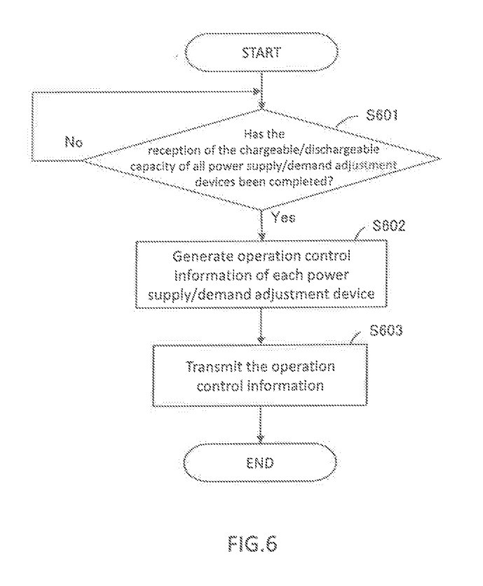

### [FIG. 6]

FIG. 6 is a flow chart for describing the operation of control device C.

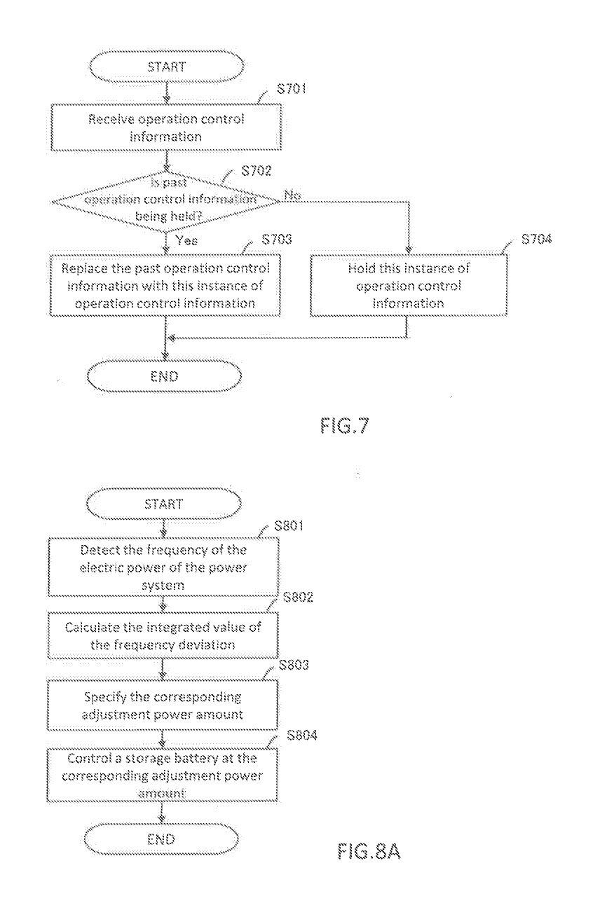

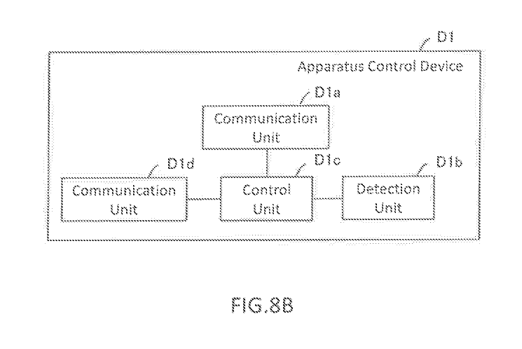

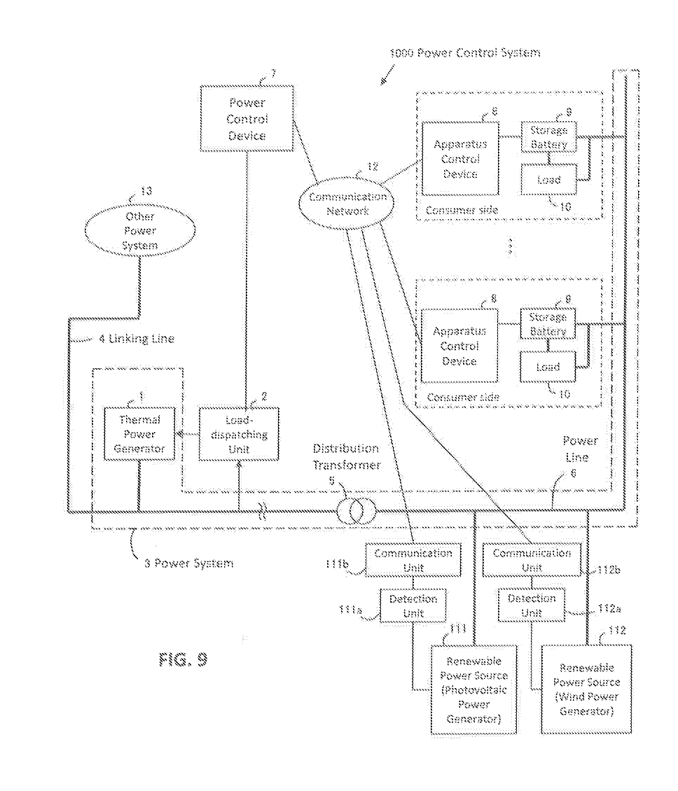

### [FIG. 7]

FIG. 7 is a How chart for describing the operation when power supply/demand adjustment device D receives operation control information.

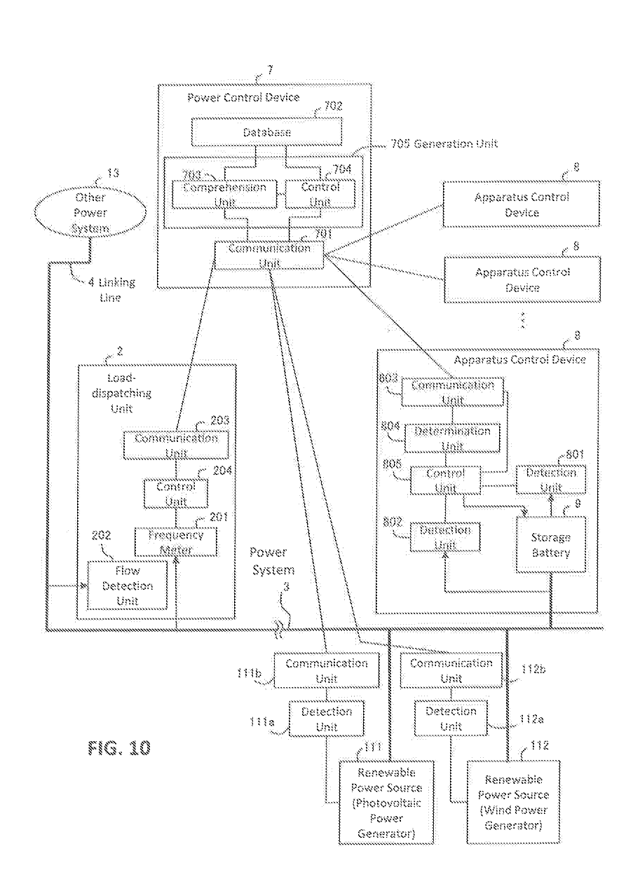

### [FIG. 8A]

FIG. 8A is a flow chart for describing the operation in which power supply/demand adjustment device D controls storage battery R2 on the basis of operation control information.

### [FIG. 8B]

FIG. 8B shows another example of apparatus control device D1.

### [FIG. 9]

FIG. 9 shows power control system 1000 that adopts the third exemplary embodiment of the present invention.

### [FIG. 10]

FIG. 10 shows an example of a load dispatching unit 2, power control device 7, and a plurality of apparatus control devices 8.

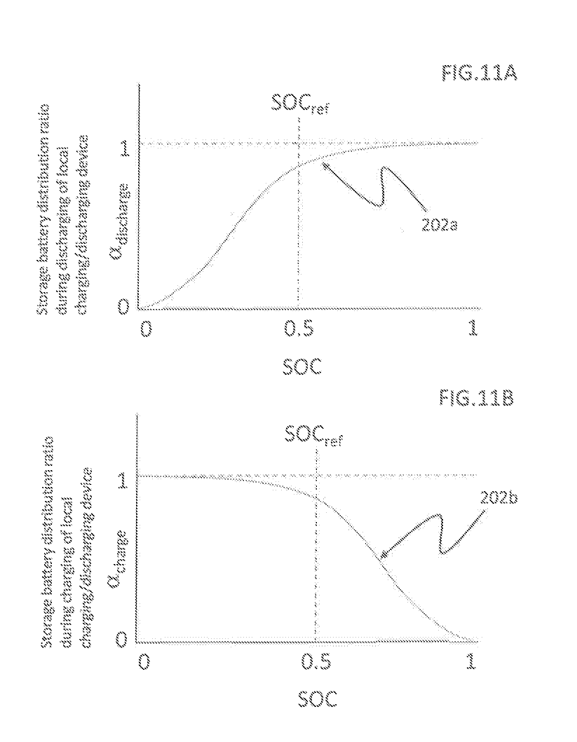

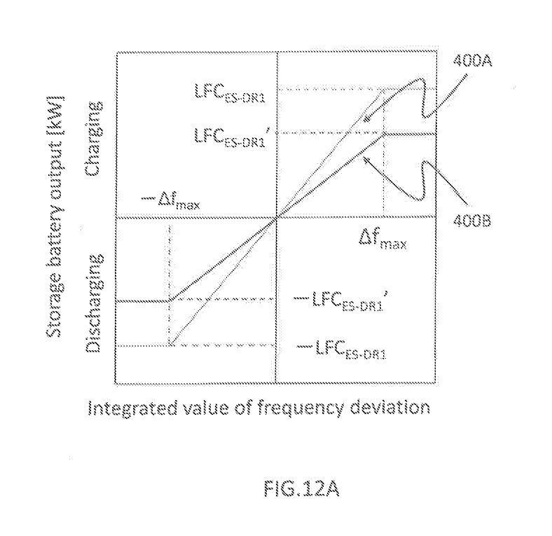

### [FIG. 11A]

FIG. 11A shows an example of storage battery distribution ratio curve 202a at the time of discharging.

### [FIG. 11B]

FIG. 11B shows an example of storage battery distribution ratio curve 202b at the time of 10 charging.

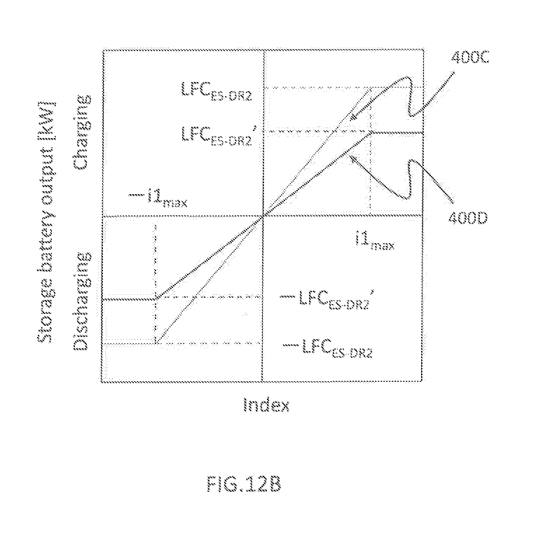

### [FIG. 12A]

FIG. 12A shows an example of the DR1 charge/discharge gain line.

### [FIG. 12B]

FIG. 12B shows an example of the DR2 charge/discharge gain line.

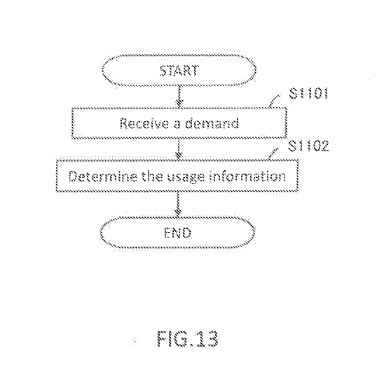

### [FIG. 13]

FIG. 13 is a flow chart for describing the operation in which apparatus control device 8 determines usage information.

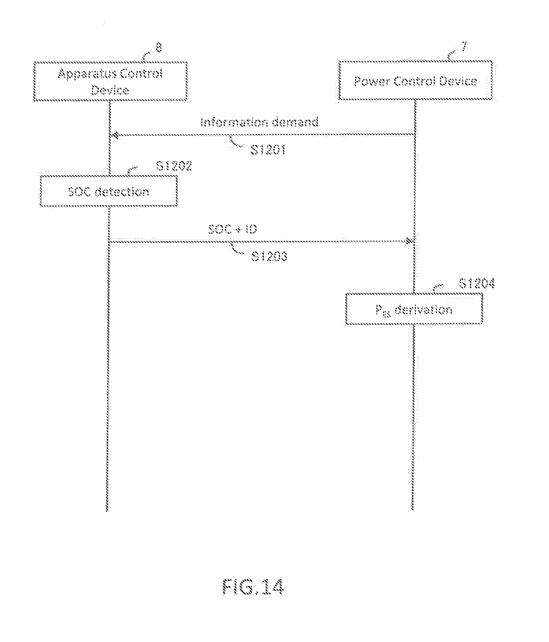

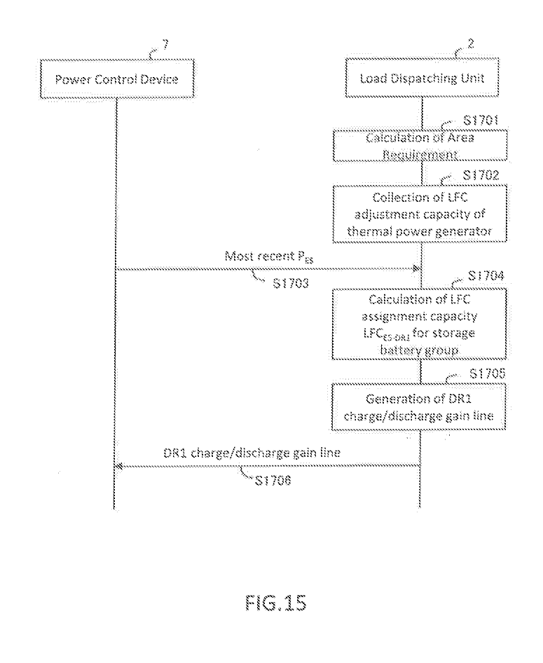

### [FIG. 14]

FIG. 14 is a sequence diagram for describing the PBS derivation operation.

### [FIG. 15]

FIG. 15 is a sequence diagram for describing the DR1 comprehension operation.

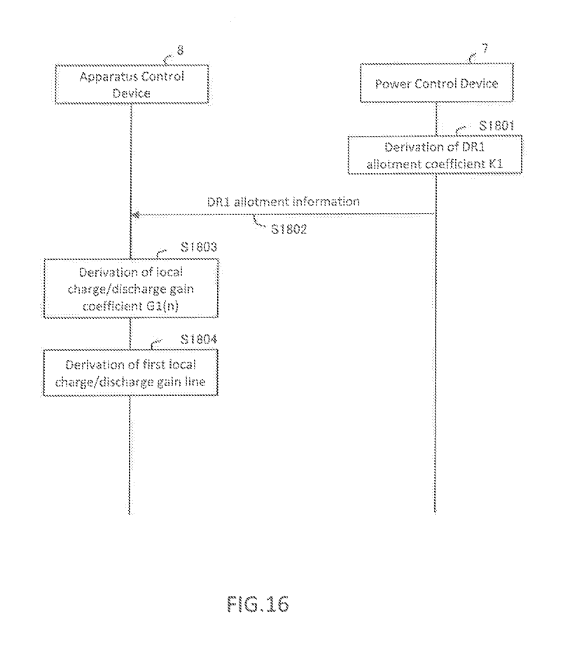

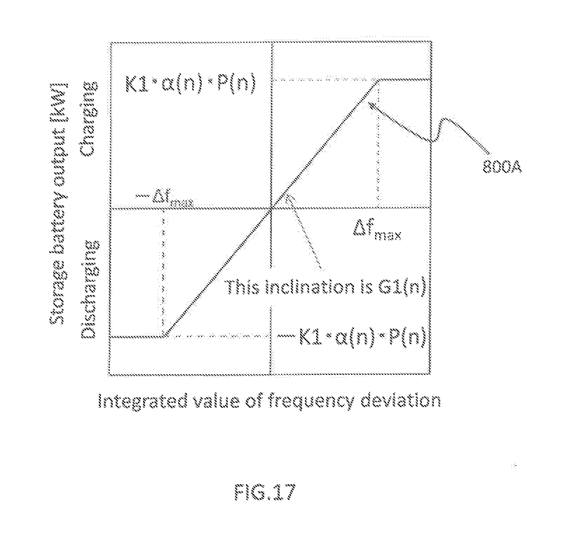

### [FIG. 16]

FIG. 16 is a sequence diagram for describing the DR1 allotment operation.

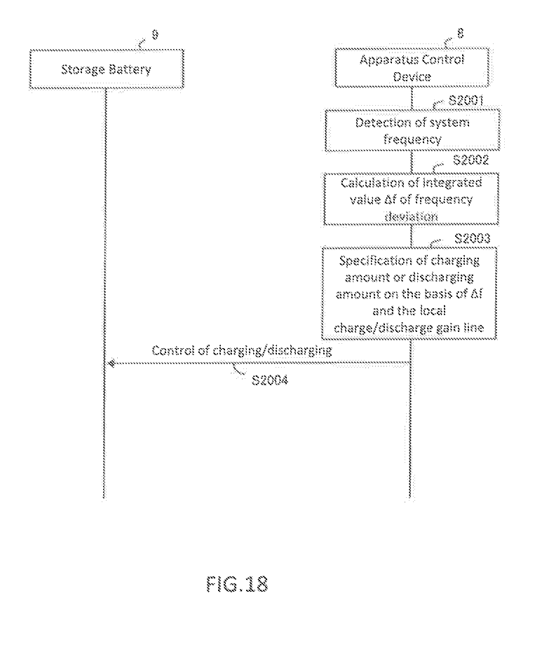

### [FIG. 17]

FIG. 17 shows an example of first local charge/discharge gain line 800A.

### [FIG. 18]

FIG. 18 is a sequence diagram for describing the charging/discharging control operation.

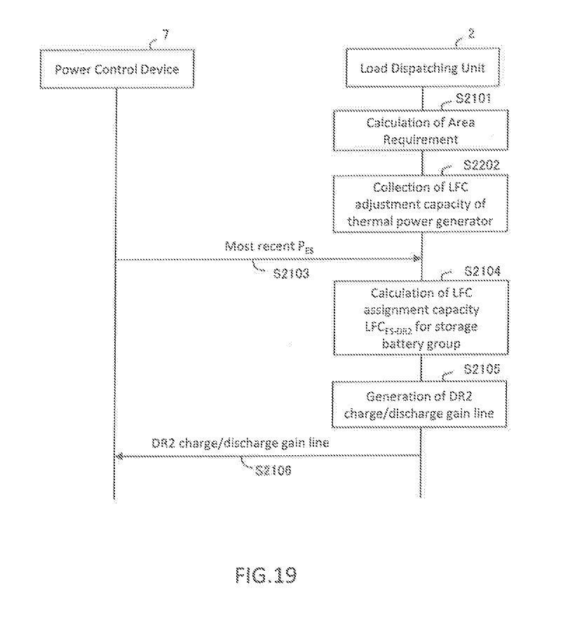

### [FIG. 19]

FIG. 19 is a sequence diagram for describing the DR2 comprehension operation.

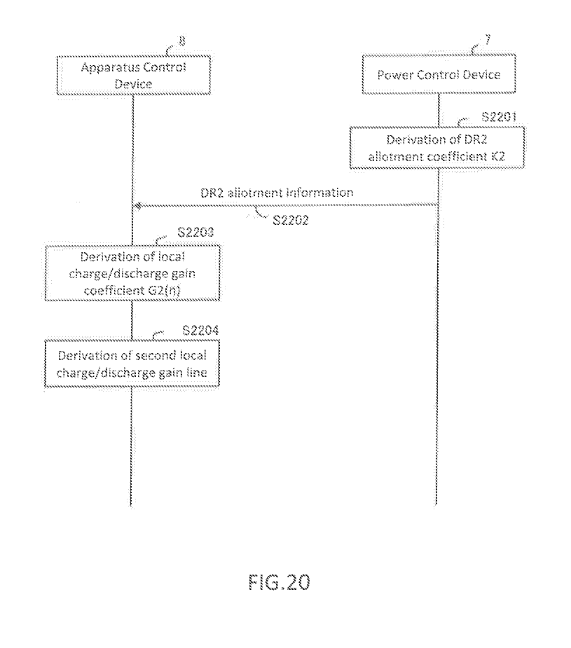

### [FIG. 20]

FIG. 20 is a sequence diagram for describing the DR2 allotment operation.

### [FIG. 21]

FIG. 21 shows an example of second local charge/discharge gain line 800B.

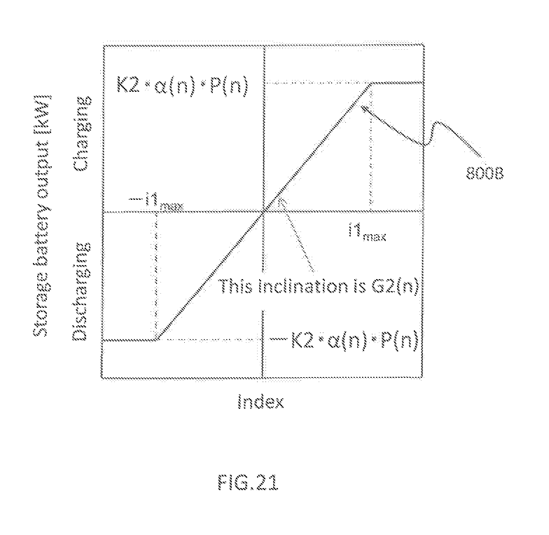

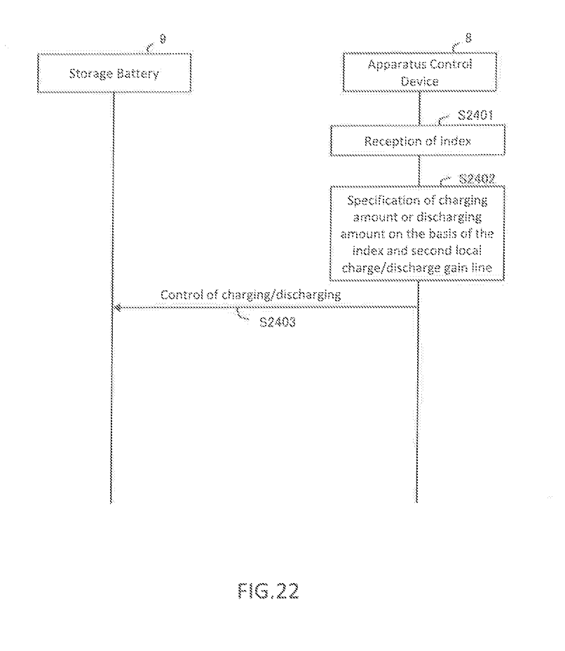

### [FIG. 22]

FIG. 22 is a sequence diagram for describing the charging/discharging control operation.

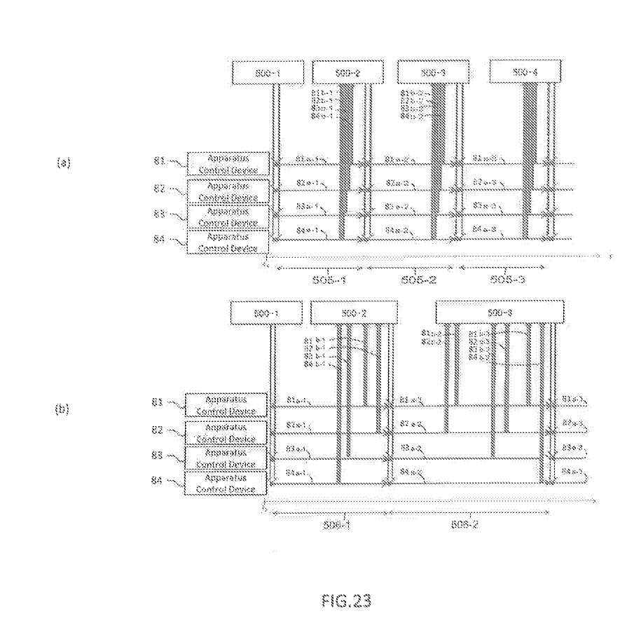

### [FIG. 23]

FIG. 23 shows the third exemplary embodiment and a comparative example.

### EXEMPLARY EMBODIMENT

Exemplary embodiments of the present invention are next described with reference to the accompanying drawings.

### First Exemplary Embodiment

FIG. 1 shows control device A of the first exemplary embodiment of the present invention.

Control device A controls a plurality of power supply/demand adjustment devices that are connected to power transmission and distribution network. The power transmission and distribution network is included in a power system. In the following explanation, the “plurality of power supply/demand adjustment devices” is also referred to as “E power supply/demand adjustment devices”. Here, E is an integer equal to or greater than 2.

A power supply/demand adjustment device adjusts the balance between supply and demand of electric power in a power transmission and distribution network. A power supply/demand adjustment device adjusts the power demand (power consumption) and the power supply (for example, discharging or power generation) in its own device to adjust the balance between supply and demand of electric power in the power transmission and distribution net-work. In addition, the power supply/demand adjustment device may also adjust the balance between supply and demand of electric power by adjusting the amount of power demand without adjusting the amount of power supply.

A power supply/demand adjustment device is, for example, a storage battery, an air conditioner, an electric water heater, a heat-pump water heater, a pump, or a freezer. However, a power supply/demand adjustment device is not limited to a storage battery, an air conditioner, an electric water heater, a heat-pump water heater, a pump or a freezer and cars be altered as appropriate. For example, an electric vehicle may also be used as a power supply/demand adjustment device.

Control device A includes generation unit A1 and transmission unit A2.

Generation unit A1 is an example of the setting unit.

Generation unit A1, at the time of receiving status information that relates to the E power supply/demand adjustment devices, sets power consumption information that indicates the power consumption of each of the E power supply/demand adjustment devices on the basis of status information of the E power supply/demand adjustment devices.

Power consumption information is an example of the operation control information for controlling the operation of the power supply/demand adjustment devices.

When a power supply/demand adjustment device is a storage battery that can be charged and discharged, the maximum power consumption of the power supply/demand adjustment device refers to the maximum charging power and the minimum power consumption of the power supply/demand adjustment device refers to the maximum discharging power.

The maximum power consumption and the minimum power consumption of a power supply/demand adjustment device are examples of status information of the power supply/demand adjustment device.

Generation unit A1 has E power supply/demand adjustment devices under its control. Generation unit A1 holds identification information of the E power supply/demand adjustment devices.

Upon completion of receiving information indicating the maximum power consumption and minimum power consumption of each of E power supply/demand adjustment devices, generation unit A1 generates power consumption information of each of the E power supply/demand adjustment devices on the basis of this information.

As one example, generation unit A1 distributes to each of the E power supply/demand adjustment devices the allotted power consumption that was allotted to control device A within a range in which the power consumption of each power supply/demand adjustment device is equal to or greater than the minimum power consumption and equal to or less than the maximum power consumption of that power supply/demand adjustment device. Generation unit A!generates, for each of the E power supply/demand adjustment devices, power consumption information that indicates the power consumption that is distributed to that power supply/demand adjustment device.

In the present exemplary embodiment, upon each completion of the reception of maximum power consumption and minimum power consumption of each of the E power supply/demand adjustment devices, generation unit At generates power consumption information of each of the E power supply/demand adjustment devices on the basis of each of the maximum power consumption and minimum power consumption amounts that were received.

In addition, according to the lime required for receiving the maximum power consumption and minimum power consumption of each of the E power supply/demand adjustment devices, generation unit A1 controls the time intervals of the time of generating (setting) power consumption information that accords with the time required for this reception and the time of the generation (setting) of power consumption information that accords with the time required for the previous reception.

For example, generation unit A1 lengthens the time intervals in proportion to the length of the time required for reception of the maximum power consumption and minimum power consumption of each of the E power supply/demand adjustment devices.

Transmission unit A2 transmits each item of power consumption information that was generated and set by generation unit A1 to the power supply/demand adjustment devices that correspond to this power consumption information.

The operation of the present exemplary embodiment is next described.

FIG. 2 is a flow chart for describing the operation of control device A.

In the present exemplary embodiment each of the E power supply/demand adjustment devices is assumed to transmit to control device A status information (the maximum power consumption and minimum power consumption) of its own device. At this time, each of the E power supply/demand adjustment devices transmits to control device A the status information of its own device and the identification information of its own device.

Generation unit A1 determines whether the reception of the status information and identification information of each of the E power supply/demand adjustment devices has been completed (Step S201).

When generation unit A1 newly receives identification information that is identical to each item of identification information that is already being held together with status information from the E power supply/demand adjustment devices during the execution of Step S201, generation unit A1 determines that the reception of the status information and identification information of each of the E power supply/demand adjustment devices has been completed.

When the reception of the status information and identification information of each of the E power supply/demand adjustment devices has been completed, generation unit A1 generates power consumption information of each of the E power supply/demand adjustment devices on the basis of the status information of each of the E power supply/demand adjustment devices (Step S202).

In Step S202, generation unit A1 first distributes to each power supply/demand adjustment device the allotted power consumption of control device A within a range in which the power consumption of each power supply/demand adjustment device is equal to or less than the maximum power consumption of that power supply/demand adjustment device and equal to or greater than the minimum power consumption of that power supply/demand adjustment device.

Generation unit A1 next generates power consumption information that indicates the power consumption that was distributed for each power supply/demand adjustment device.

When the allotted power consumption of control device A is greater than the sum total of the maximum power consumption of the power supply/demand adjustment devices, generation unit A1 generates, for example, power consumption information that indicates the maximum power consumption of each power supply/demand adjustment device as the power consumption of each power supply/demand adjustment device.

Generation unit A1 next supplies the power consumption information of each power supply/demand adjustment device to transmission unit A2.

Transmission unit A2, having received the power consumption information of each power supply/demand adjustment device, transmits power consumption information to each of the power supply/demand adjustment devices that correspond to the power consumption information (Step S203).

Upon receiving the power consumption information, each power supply/demand adjustment device consumes electric power at the power consumption that is indicated in the power consumption information. The operation of the power supply/demand adjustment devices is thus controlled by power consumption information.

When the process of Step S203 has been completed, generation unit A1 again executes Step S201. As a result, the processes of Steps S201-S203 are repeated.

The effect of the present exemplary embodiment is next described.

In the present exemplary embodiment, at the time of receiving the maximum power consumption and minimum power consumption of the E power supply/demand adjustment devices that are under its control, generation unit A1 generates power consumption information of each of E power supply/demand adjustment devices on the basis of the maximum power consumption and minimum power consumption of these devices. Transmission unit A2 transmits the power consumption information to each of the power supply/demand adjustment devices that correspond to the power consumption information.

As a result, even when the maximum power consumption and minimum power consumption of the E power supply/demand adjustment devices that are under control cannot be received within a fixed time interval power consumption information that controls the operation of the E power supply/demand adjustment devices can be generated and transmitted.

For example, even when there is variation among the E power supply/demand adjustment devices regarding the times of the transmission of the maximum power consumption and minimum power consumption, the power consumption information of the E power supply/demand adjustment devices can be generated and transmitted.

In addition, generation unit A1 generates, for each completion of the reception of the maximum power consumption and minimum power consumption amounts of the E power supply/demand adjustment devices that are under its control, power consumption information of the E power supply/demand adjustment devices on the basis of the maximum power consumption and minimum power consumption.

As a result power consumption information of the E power supply/demand adjustment devices can be updated on the basis of the most recent maximum power consumption and the most recent minimum power consumption of the E power supply/demand adjustment devices.

In addition, in accordance with the execution time of Step S201 (the time required for reception), generation unit A1 controls the time intervals of the generation (setting) time of the power consumption amount information that corresponds to Step S201 and the generation (setting) time of the power consumption amount information that corresponds to the previous Step S201.

In the present exemplary embodiment generation unit A1 lengthens the time interval of the generation (setting) time of power consumption information that corresponds to the current Step S201 and the generation (setting) time of power consumption information that corresponds to the previous Step S201 in proportion to the length of the execution time of Step S201.

As a result, the transmission time (time interval) in the E power supply/demand adjustment devices can be altered in accordance with these variations.

A modification of the present exemplary embodiment is next described.

In the present exemplary embodiment, the maximum power consumption and minimum power consumption of power supply/demand adjustment devices were used as the status information of the power supply/demand adjustment devices, but when the power supply/demand adjustment devices are storage batteries, the SOC (State of Charge) may also be used as the status information of the power supply/demand adjustment devices.

In this case, assuming that each of the power supply/demand adjustment devices is of the same configuration, generation unit A1 may operate as shown below.

Generation unit A1 increases the value of the power consumption that is distributed to a power supply/demand adjustment device in inverse proportion to the level of the SOC of the power supply/demand adjustment device.

### Second Exemplary Embodiment

FIG. 3 shows a power control system that includes control device C of the second exemplary embodiment of the present invention.

An overview of the power control system is first described.

The power control system includes control device C and a plurality of power supply/demand adjustment devices D.

Control device C controls the plurality of power supply/demand adjustment devices D that are connected to power system 111. Control device C has the plurality of power supply/demand adjustment devices D under its control. For example, Control device C holds identification information of the plurality of power supply/demand adjustment devices D. Power system R1 is connected to another power system R4 by way of linking line R3.

Power supply/demand adjustment devices D adjust the balance between supply and demand of electric power in power system R1. For example, power supply/demand adjustment devices D adjust the balance between supply and demand of electric power in power system R1 by controlling the power demand (for example, charging) and supply of electric power (for example, discharging) of storage batteries R2.

Power supply/demand adjustment device D transmits the chargeable/dischargeable capacity of storage battery R2 to control device C. In the following explanation, the “chargeable/dischargeable capacity of storage battery R2” is also referred to as simply “chargeable/dischargeable capacity”. At this time, power supply/demand adjustment device D transmits the identification information of its own device to control device C together with the chargeable/dischargeable capacity.

The chargeable/dischargeable capacity is an example of the status information of power supply/demand adjustment device D. The chargeable/dischargeable capacity may be the capacity of a storage battery that the owner of storage battery R2 has offered to supply according to, for example, a contract, or may be specified using the SOC of storage battery R2.

A method in which a table that shows the correspondence relation between the SOC of storage battery R2 and the chargeable/dischargeable capacity is used to specify the chargeable/dischargeable capacity from the SOC may be used as a method of specifying the chargeable/dischargeable capacity by using the SOC of storage battery R2. This table is held in, for example, control unit D1c in power supply/demand adjustment device D. A table that shows a relation in which the chargeable/dischargeable capacity is a maximum when the SOC is 0.5 and in which the chargeable/dischargeable capacity decreases to the extent of divergence of the SOC from 0.5 is used as this table. In this case, the SOC is also an example of the status information of power supply/demand adjustment device D.

Control device C waits until the reception of the chargeable/dischargeable capacity from ail power supply/demand adjustment devices D that are under its control.

When the reception of the chargeable/dischargeable capacity has been completed for all power supply/demand adjustment devices D that are under its control, control device C generates operation control information for controlling the operation of power supply/demand adjustment devices D for each power supply/demand adjustment device D on the basis of each chargeable/dischargeable capacity. When the identification information of ail power supply/demand adjustment devices D under control is received together with the chargeable/dischargeable capacity, control device C thereupon determines that the chargeable/dischargeable capacity has been received from all power supply/demand adjustment devices D that are under control.

FIG. 4 shows an example of the operation control information.

The operation control information shown in FIG. 4 shows the relation between the integrated value of the frequency deviation of the power in power system R1 (hereinbelow also referred to as simply “frequency deviation”) and the adjustment power amount (the LFC (Load Frequency Control) adjustment power amount) of storage battery R2.

This operation control information is operation control information for causing power supply/demand adjustment devices D to execute an LFC adjustment process.

A positive-value adjustment power amount (LFC adjustment power amount) indicates charging of storage battery R2. A negative-value adjustment power amount (LFC adjustment power amount) indicates discharging of storage battery R2. The frequency deviation is calculated by using the formula “frequency of electric power of power system R1”—“reference frequency of the electric power of power system R1 (for example, 50 Hz)”. The reference frequency of power system R1 is stored in control unit D1c in apparatus control device D1.

Control device C generates operation control information such that, for example, the adjustment power amount of storage battery R2 (see FIG. 4) is equal to or lower than the chargeable/dischargeable capacity of storage battery R2.

Control device C transmits operation control information to each corresponding power supply/demand adjustment device D.

Upon receiving operation control information, power supply/demand adjustment device D (for example, control unit D1c to be described hereinbelow) holds the operation control information. When previously received operation control information is held at the time of receiving the operation control information, power supply/demand adjustment device D (for example, control unit D1c) replaces the operation control information that is being held with the operation control information that was newly received. This replacement refers to “overwrite saving” or “replacement saving”.

Having held the newly received operation control information, power supply/demand adjustment device D detects the frequency of power system R1 at period T2. Period T2 is, for example, 0.5-1 second. However, period T2 is not limited to 0.5-1 second.

Power supply/demand adjustment device D (for example, control unit D1c) uses the formula “frequency of electric power of power system R1”—“reference frequency of electric power of power system R1” to calculate the frequency deviation. Power supply/demand adjustment device D (for example, control unit D1c) next calculates the integrated value of the frequency deviation.

Power supply/demand adjustment device D (for example, control unit D1c) uses the operation control information that is being held (see FIG. 4) to specify the adjustment power amount that corresponds to the integrated value of the frequency deviation (hereinbelow referred to as “corresponding adjustment power amount”).

Power supply/demand adjustment device D controls the charging or discharging of storage battery R2 at the corresponding adjustment power amount. The LFC adjustment process is realized by means of this control.

The operation of detecting the state (frequency) of power system R1 is executed by detection unit D1b, to be described. In addition, the operation of controlling the operation of storage battery R2 on the basis of the operation control information and the integrated value of the frequency deviation of power system R1 is executed by control unit D1c.

Details of the power control system are next described.

Control device C is first described.

Control device C includes generation unit C1 and communication unit C2.

Communication unit C2 is an example of the transmission unit. Communication unit C2 communicates with each power supply/demand adjustment device D. For example, Communication unit C2 receives the chargeable/dischargeable capacity from power supply/demand adjustment devices D. Communication unit C2 further transmits operation control signals to power supply/demand adjustment devices D.

Generation unit C1 waits until receiving chargeable/dischargeable capacity from all power supply/demand adjustment devices D that are under its control.

When the reception of the chargeable/dischargeable capacity of all power supply/demand adjustment devices D that are under control has been completed, generation unit C1 generates operation control information of each power supply/demand adjustment device D on the basis of the chargeable/dischargeable capacities that were received. The method of generating this operation control information is the same as the method described above by which control device C generates operation control information.

Power supply/demand adjustment device D is next described.

Power supply/demand adjustment device D includes apparatus control device D1 and storage battery R2. Power supply/demand adjustment device D also functions as, for example, a storage device. Apparatus control device D1 is an example of a control device. Apparatus control device D1 includes communication unit D1a, detection unit D1b, and control unit D1c.

Communication unit D1a is an example of a communication means. Communication unit D1a communicates with control device C. For example, communication unit D1a transmits the chargeable/dischargeable capacity of storage battery R2 together with identification information to control device C. In addition, communication unit D1a receives operation control information from control device C. Control device C is an example of the outside device.

Detection unit D1b is an example of the detection means. Detection unit D1b detects the frequency of the electric power of power system R1 (the system frequency).

Control unit D1c is an example of the control means. Control unit D1c controls apparatus control device D1 and storage battery R2. For example, control unit D1c uses the detection result of detection unit D1b to calculate the integrated value of frequency deviation.

Control unit D1c further controls the operation (charging or discharging) of storage battery R2 on the basis of the operation control information and the integrated value of the frequency deviation. The method of this control of the operation of storage battery R2 is similar to the method described hereinabove by which power supply/demand adjustment device D controls the operation of storage battery R2.

The operation of the present exemplary embodiment is next described.

The operation by which power supply/demand adjustment device D transmits chargeable/dischargeable capacity is first described.

FIG. 5 is a flow chart for describing the operation by which power supply/demand adjustment device D transmits the chargeable/dischargeable capacity.

In power supply/demand adjustment device D, control unit D1c detects the SOC of storage battery R2 (Step S501).

Control unit D1c next uses a table that shows the correspondence relation of the SOC of storage battery R2 and the chargeable/dischargeable capacity to specify the chargeable/dischargeable capacity from the SOC (Step S502). This table is assumed to be held in advance in control unit D1c

Control unit D1c next transmits the chargeable/dischargeable capacity together with the identification information of its own device to control device C by way of communication unit D1a (Step S503).

Control unit D1c repeats the series of operations of Steps S501-S503. The time intervals of this series of operations may or may not be determined hi advance for each power supply/demand adjustment device D.

The operation of control device C is next described.

FIG. 6 is a flow chart for describing the operation of control device C.

Upon receiving the chargeable/dischargeable capacity and identification information from each power supply/demand adjustment device D in control device C, communication unit C2 supplies the chargeable/dischargeable capacity and identification information to generation unit C1.

Generation unit C1 waits until completion of the reception of the chargeable/dischargeable capacity of all power supply/demand adjustment devices D that are under the control of control device C (Step S601).

When all identification information that is identical to each item of identification information that is already held is newly received together with chargeable/dischargeable capacity during execution of Step S601, generation unit C1 determines that the reception of the chargeable/dischargeable capacity of all power supply/demand adjustment devices D under its control has been completed.

When the reception of chargeable/dischargeable capacity of all power supply/demand adjustment devices D has been completed, generation unit C1 generates operation control information for each power supply/demand adjustment device D on the basis of chargeable/dischargeable capacity of each device (Step S602). This operation control information shows the relation between the integrated value of frequency deviation and the adjustment power amount in storage battery R2 in power supply/demand adjustment device D (see FIG. 4).

In Step S602, generation unit C1 generates operation control information for each power supply/demand adjustment device D such that the absolute value of the adjustment power amount of storage battery R2 in power supply/demand adjustment device D (see FIG. 4) is equal to or less than the chargeable/dischargeable capacity of that storage battery R2.

Generation unit C1 further increases the maximum value of the absolute value of the adjustment power amount in the operation control information that corresponds to power supply/demand adjustment device D according to the magnitude of the chargeable/dischargeable capacity of that power supply/demand adjustment device D.

Still further, generation unit C1 alters the operation control information according to a power adjustment amount undertaken by control device C1 (for example, the power adjustment amount that is entrusted from a power company or the power adjustment amount that has been successfully bid on the power market). For example, generation unit C1 generates operation control information for each power supply/demand adjustment device D such that the total amount of the adjustment power amount (see FIG. 4) of each storage battery R2 in the integrated value of a particular frequency deviation coincides with the power adjustment amount undertaken by control device C for the integrated value of the frequency deviation.

Generation unit C1 next causes communication unit C2 to execute a process of transmitting to each power supply/demand adjustment device D the operation control information that corresponds to that power supply/demand adjustment device D (Step S603).

When the process of Step S603 has been completed, control device C again executes the processes of Steps S601-S603. As a result, the series of processes of Steps S601-S603 are repeated.

The operation when power supply/demand adjustment device D has received operation control information is next described.

FIG. 7 is a flow chart for describing the operation when power supply/demand adjustment device D has received operation control information.

Communication unit D1a, upon receiving operation control information (Step S701), supplies the operation control information to control unit D1c.

Control unit D1c, having received the operation control information, determines whether operation control information that was received in the past is being held (Step S702).

When operation control information that was received in the past is being held, control unit D1c replaces the operation control information that was received in the past with the operation control information that was received this time (Step S703). Control unit D1c deletes the operation control information that was received in the past by executing the process of Step S703 and holds the operation control information that was received this time.

On the other hand, when operation control information that was received in the past is not being held, control unit D1c holds the operation control information that was received this time (Step S704).

The operation by which power supply/demand adjustment device D controls storage battery R2 on the basis of operation control information is next described.

FIG. 8A is a flow chart for describing the operation by which power supply/demand adjustment device D controls storage battery R2 on the basis of operation control information.

Apparatus control device D1 in power supply/demand adjustment device D repeats the operation shown below at period T2.

Detection unit D1b detects the frequency of the electric power of power system R1 (Step S801). Detection unit D1b next supplies the frequency of the electric power of power system R1 to control unit D1c.

Control unit D1c, upon receiving the frequency of power system R1, uses the formula “frequency of electric power of power system R1”—“reference frequency of electric power of power system R1” to calculate the frequency deviation. Control unit D1c next calculates the integrated value of the frequency deviation (Step S802).

Control unit D1c uses the operation control information that is being held (see FIG. 4) to specify the adjustment power amount that corresponds to the integrated value of the frequency deviation (corresponding adjustment power amount) (Step S803).

Control unit D1c next controls the charging or discharging of storage battery R2 at the corresponding adjustment power amount (Step S804).

The effect of the present exemplary embodiment is next described.

In the present exemplary embodiment, at a time that accords with the completion of reception of the chargeable/dischargeable capacity of all power supply/demand adjustment devices D that are under control, generation unit C1 generates operation control information of each power supply/demand adjustment device D on the basis of the chargeable/dischargeable capacity Communication unit C2 transmits operation control information to each power supply/demand adjustment device D that corresponds to the operation control information.

As a result, generation unit C1 is able to generate and transmit operation control information of each power supply/demand adjustment device D even when the chargeable/dischargeable capacity of all power supply/demand adjustment devices D under control cannot be received within the fixed time interval that has been set in advance. As a result, power supply/demand adjustment that uses power supply/demand adjustment devices that are under control can be executed with good accuracy

In addition, power supply/demand adjustment devices D are able to control the operation of storage batteries R2 at period T2 on the basis of operation control information that accords with the most recent chargeable/dischargeable capacity and the integrated value of the frequency deviation. The operation control information corresponds to the most recent chargeable/dischargeable capacity, and the operation of storage batteries R2 can therefore be controlled with high accuracy.

When there is variation among the plurality of power supply/demand adjustment devices D regarding the transmission times of chargeable/dischargeable capacity, the generation interval of operation control information is believed to become lengthy as a result of this variation. However, change of the chargeable/dischargeable capacity of storage batteries R2 is not as fast as change of the integrated value of the frequency deviation. As a result, the operation of storage batteries R2 can be controlled with a certain degree of accuracy by continuing to use operation control information that has already been received.

A modification of the present exemplary embodiment is next described.

When the execution time of Step S601 is shorter than a minimum execution time that has been set in advance, generation unit C1 may execute a process that follows Step S602 after the passage of the minimum execution time after starting execution of Step S601.

In this case, the repeated generation of similar operation control information can be prevented in a state in which, for example, there has been virtually no change of each chargeable/dischargeable capacity.

In the present exemplary embodiment (including the modification), power supply/demand adjustment device D controls storage battery R2 on the basis of operation control information and the integrated value of the frequency deviation, but an index that is determined on the basis of the frequency deviation and power flow of linking line R3 can be used in place of the integrated value of the frequency deviation. In this case, operation control information that indicates the relation between the index and the adjustment power amount of storage batteries R2 in processing-object power supply/demand adjustment devices D is used as the operation control information. For example, the column of the integrated value of the frequency deviation shown in FIG. 4 becomes the column of the index. The index is an example of an index relating to the adjustment power amount.

The index is generated by a predetermined device (for example, a load dispatching unit or control device C) at period T2.

The index is determined as shown below.

(A) when power is supplied from power system R1 to another power system R4 by way of linking line R3:

The power that is supplied from power system R1 to another power system R4 by way of linking line R3 is multiplied by a predetermined coefficient (positive value). The integrated value of the value obtained by adding the result of this multiplication to the frequency deviation is determined as the index. The addition value is a corrected frequency deviation in which the frequency deviation has been corrected by the power flow of linking line R3.

(B) when power is supplied from another power system R4 to power system R1 by way of linking line R3:

The power that is supplied from another power system R4 to power system R1 by way of linking line R3 is multiplied by the above-described predetermined coefficient. The integrated value of a value obtained by subtracting the result of this multiplication from the frequency deviation is determined as the index. The subtraction value is a corrected frequency deviation in which the frequency deviation is corrected by the power flow of linking line R3.

With each generation of the index at period T2, a predetermined device uses one-way communication or bidirectional communication (for example, 1-to-N bidirectional communication) to transmit this index to each power supply/demand adjustment device D.

By means of communication unit D1a, power supply/demand adjustment device D uses one-way communication or bidirectional communication (such as 1-to-N bidirectional communication) to receive and comprehend this index. Communication unit D1a supplies the received index to control unit D1c. In this case, communication unit D1a serves as both a comprehension means and a comprehension unit.

Further, communication unit that differs from communication unit D1a may also use one-way communication or bidirectional communication (for example, 1-to-N bidirectional communication) to receive the index and comprehend the index.

FIG. 8B shows an example of apparatus control device D1 in which communication unit D1d that differs from communication unit D1a uses one-way communication or bidirectional communication (such as 1-to-N bidirectional communication) to receive and comprehend an index. In FIG. 8B, constituent elements that are identical to elements shown in FIG. 3 are given the same reference numbers. Communication unit D1d is an example of the comprehension means.

Control unit D1c repeats the operation shown below at period T2.

Control unit D1c, upon receiving the index from communication unit D1a, uses operation control information that is being held to specify the adjustment power amount that corresponds to the index (corresponding adjustment power amount).

Control unit D1c next controls the charging or discharging of storage battery R2 at the corresponding adjustment power amount.

The index is information that cannot be acquired despite investigation of power system R1. By receiving an index that is transmitted from a predetermined device, apparatus control device D1 is able to obtain an index that cannot be acquired despite investigation of power system R1.

In addition, the power flow of linking line R3 is reflected in the index. As a result, as information that corresponds to the supply/demand adjustment amount of the overall power system, the index has higher accuracy than the integrated value of the frequency deviation. Accordingly, power supply/demand adjustment can be performed with good accuracy.

When using the above-described index, detection unit D1b can be omitted.

In the present exemplary embodiment, an example was shown in which generation unit C1 waits until chargeable/dischargeable capacity has been received from all power supply/demand adjustment devices D that are under control.

However, at the time of having received the chargeable/dischargeable capacity from, of all power supply/demand adjustment devices D that are under control, a predetermined percentage (for example, 70% of the entirety) of power supply/demand adjustment devices D, generation unit C1 may also set the operation control information of the predetermined percentage of power supply/demand adjustment devices D on the basis of this chargeable/dischargeable capacity. The predetermined percentage is not limited to 70% of the entirety and can be altered as appropriate.

In this case, generation unit C1 determines the chargeable/dischargeable capacity from the predetermined percentage of power supply/demand adjustment devices D as the chargeable/dischargeable capacity from processing-object power supply/demand adjustment devices D. Generation unit C1 then determines the most recent chargeable/dischargeable capacity of the chargeable/dischargeable capacity of non-processing-object power supply/demand adjustment devices D that was received in the past as the chargeable/dischargeable capacity of the remaining power supply/demand adjustment devices D (non-processing-object power supply/demand adjustment devices D). By carrying out this operation, generation unit C1 recognizes the chargeable/dischargeable capacity of all power supply/demand adjustment devices D.

Generation unit C1 subsequently sets the operation control information of all power supply/demand adjustment devices D as described above and transmits the operation control information of the predetermined percentage of power supply/demand adjustment devices D to the predetermined percentage of power supply/demand adjustment devices D by way of communication unit C2.

In this case, in power supply/demand adjustment devices D that did not transmit chargeable/dischargeable capacity or that sent chargeable/dischargeable capacity bin for which this chargeable/dischargeable capacity did not reach control device C, control unit D1c controls the operation of storage batteries R2 at period T2 on the basis of, for example, past operation control information that is being held in control unit D1c and the integrated value of the frequency deviation (or an index). In this case, circumstances in which power supply/demand adjustment device D (for example, control unit D1c) did not transmit the chargeable/dischargeable capacity include cases in which power supply/demand adjustment device D (for example, control unit D1c) intentionally did not transmit the chargeable/dischargeable capacity and cases in which power supply/demand adjustment device D unintentionally did not (could not) transmit the chargeable/dischargeable capacity due to the occurrence of a communication breakdown.

In addition, generation unit C1 may also operate as shown below when, at the time of having received chargeable/dischargeable capacity from a predetermined percentage of power supply/demand adjustment devices D (processing-object power supply/demand adjustment devices D) from among all power supply/demand adjustment devices D under control, the predetermined percentage of the operation control information of power supply/demand adjustment devices D are set on the basis of the chargeable/dischargeable capacity.

Generation unit Ci generates the operation control information of processing-object power supply/demand adjustment devices D by using the chargeable/dischargeable capacity that was received from processing-object power supply/demand adjustment devices D and by not using the chargeable/dischargeable capacity of non-processing-object power supply/demand adjustment devices D.

In this case, generation unit C1 generates the operation control information such that, for each processing-object power supply/demand adjustment device D, the absolute value of the adjustment power amount (see FIG. 4) in storage battery R2 in processing-object power supply/demand adjustment device D is equal to or less than the chargeable/dischargeable capacity of that storage battery R2.

Generation unit C1 further increases the maximum value of the absolute value of the adjustment power amount in operation control information in proportion to the magnitude of the chargeable/dischargeable capacity of processing-object power supply/demand adjustment devices D.

Generation unit C1 further alters operation control information according to the power adjustment amount that control device C undertakes. For example, generation unit C1 generates operation control information for each processing-object power supply/demand adjustment device D such that the total amount of adjustment power amount (see FIG. 4) in storage battery R2 in each processing-object power supply/demand adjustment device D in the integrated value of a certain frequency deviation coincides with the power adjustment amount that control device C undertakes for that integrated value of frequency deviation.

In the present exemplary embodiment, a device or apparatus (such as an air conditioner, electric water heater, heat-pump water heater, pump, freezer or electric vehicle) that adjusts the amount of power demand to adjust balance between supply and demand of electric power may be used in place of storage battery R2. In this case, the amount of electric power that can be consumed (consumable power capacity) should be used in place of the chargeable/dischargeable capacity.

In the present exemplary embodiment, a renewable energy source that is provided with an output control capability such as a photovoltaic power generator or a wind power generator may be used in place of storage battery R2. In this case, the estimated value of the maximum amount of power than can be generated (maximum generation capacity) should be used in place of the chargeable/dischargeable capacity.

### Third Exemplary Embodiment

FIG. 9 shows power control system 1000 that adopts the third exemplary embodiment of the present invention.

Power control system 1000 includes: thermal power generator 1, load dispatching unit 2, power system 3, linking line 4, distribution transformer 5, power line 6, power control device 7, a plurality of apparatus control devices 8, a plurality of storage batteries 9, and a plurality of loads 10. Power control device 7 is an example of the control device.

Thermal power generator 1, load dispatching unit 2, power system 3, linking line 4, distribution transformer 5, and power line 6 are owned by a power company.

Power control device 7 is a device that is owned by a PPS (Power Producer and Supplier). Power control device 7 may also be owned by an aggregator.

Apparatus control devices 8, storage batteries 9, and loads 10 are devices owned by each consumer. Each consumer may be a typical residence or may be a structure such as a building.

Thermal power generator 1, distribution transformer 5, and power line 6 are included in power system 3. Renewable power source (photovoltaic power generator) 111 and renewable power source (wind power generator) 112 are connected to power system 3.

In FIG. 9, one renewable power source 111 and one renewable power source 112 are shown, but in actuality, a plurality of renewable power sources 111 and a plurality of renewable power sources 112 are connected to power system 3.

Detection unit 111a detects the generation amount of renewable power source 111. Communication unit 111b reports the detection result of detection unit 111a to power control device 7. Detection unit 111a and communication unit 111b are provided for each renewable power source 111.

Detection unit 112a detects the generation amount of renewable power source 112. Communication unit 112b reports the detection result of detection unit 112a to power control device 7. Detection unit 112a and communication unit 112b are provided for each renewable power source 112.

Storage batteries 9 are an example of the power supply/demand adjustment device. Storage batteries 9 are connected to power system 3. Loads 10 are, for example, household appliances.

An overview of the functions belonging to power control system 1000 is first described.

Load dispatching unit 2 on the power company side transmits demands for power supply/demand adjustment processes to power control device 7 on the PPS side.

Power control device 7 on the PPS side receives the demands of the power company from load dispatching unit 2.

Power control device 7 generates operation control information for controlling storage batteries 9 for each apparatus control device 8. At this time, power control device 7 generates operation control information that reflects the status information of storage batteries 9 (for example, the residual capacity or the SOC) and the content of the power supply/demand adjustment process that accords with a demand (for example, LFC).

In the present exemplary embodiment, in accordance with the completion of reception of status information of all apparatus control devices 8, power control device 7 generates operation control information that corresponds to all apparatus control devices 8.

When the demand is a “first LFC demand”, power control device 7 generates first LFC operation control information for executing a first LFC adjustment process (hereinbelow also referred to as “DR application 1”) that controls the operation of storage batteries 9 using the integrated value of the frequency deviation of power system 3.

When the demand is a “second LFC demand”, power control device 7 generates second LFC operation control information for executing a second LFC adjustment process (hereinbelow also referred to as “DR application 2”) that controls the operation of storage batteries 9 using an index. The index here is similar to the index described in the modification of the second exemplary embodiment.

In the following explanation, each storage battery 9 is assumed to be assigned to DR applications 1-2.

Power control device 7 transmits the demand that was received to apparatus control devices 8.

Power control device 7 repeatedly transmits the operation control information to apparatus control devices 8 with time intervals interposed.

Power control device 7 repeatedly transmits an index to apparatus control devices 8 with time intervals interposed.

The transmission spacing of the operation control information is preferably longer than the transmission spacing for an index.

Upon receiving a demand, apparatus control device 8 determines, according to the demand, the usage information (either of the frequency of power system 3 and the index and operation control information that accords with the demand) that is to be used in the power supply/demand adjustment process that corresponds to the demand.

Apparatus control device 8 executes the power supply/demand adjustment process (DR applications 1-2) that accords with the demand by using the usage information to control the operation of storage battery 9. The power supply/demand adjustment process that accords with the demand is the response to the demand (hereinbelow also referred to the “response”).

The configuration of power control system 1000 is next described.

Thermal power generator 1 is an example of a power generator. Load dispatching unit 2 communicates with power control device 7. Load dispatching unit 2 transmits demands (first LFC demands and second LFC demands) to power control device 7. Power system 3 is a system that supplies electric power to the consumer side. Power system 3 converts the voltage of the generated power that is supplied from thermal power generator 1 to a predetermined voltage at distribution transformer 5. Power system 3 supplies the electric power of the predetermined voltage to the consumer side.

Linking line 4 connects power system 3 with another power system 13. Power control device 7 receives demands (first LFC demands and second LFC demands) of a power company from load dispatching unit 2.

Power control device 7 produces operation control information for each of DR applications 1 and 2.

Power control device 7 transmits the demands that are received to apparatus control device 8. Power control device 7 repeatedly transmits the operation control information to apparatus control device 8 with time intervals interposed. Power control device 7 repeatedly transmits an index to apparatus control device 8 with time intervals interposed.

In accordance with a demand that was received from power control device 7, apparatus control device 8 determines the usage information that is to be used in the power supply/demand adjustment process that corresponds to the demand. Apparatus control device 8 uses the usage information to control the operation of storage battery 9.

FIG. 10 shows an example of load dispatching unit 2, power control device 7, and a plurality of apparatus control devices 8. In FIG. 10, constituent elements that are identical to elements shown in FIG. 9 are given the same reference numbers. In FIG. 10, communication network 12 is omitted. In FIG. 10, storage batteries 9 are incorporated in apparatus control devices 8, but storage batteries 9 are not necessarily incorporated in apparatus control devices 8. Apparatus control device 8 that incorporates storage battery 9 is an example of a storage device.

Apparatus control device 8 is first described.

Apparatus control device 8 controls the operation of storage battery 9. Apparatus control device 8 includes detection units 801 and 802, communication unit 803, determination unit 804, and control unit 805.

Detection unit 801 detects the SOC of storage battery 9. The SOC of storage battery 9 is a value in a range of from 0 to 1. The SOC of storage battery 9 represents the status information of storage battery 9. The status information of storage battery 9 is not limited to the SOC of storage battery 9 and can be altered as appropriate. For example, the cell temperature, current amount, or voltage may also be used as the status information of storage battery 9.

Detection unit 802 detects the frequency of power system 3. Detection unit 802 may be inside or outside apparatus control device 8. When detection unit 802 is outside apparatus control device 8, control unit 805 detects (receives) the frequency of power system 3 by receiving the detection result of detection unit 802.

Communication unit 803 is an example of a reception unit or transmission/reception unit. Communication unit 803 communicates with power control device 7.

Communication unit 803 receives demands, operation control information, and indexes from power control device 7.

For example, communication unit 803 receives demands that are transmitted from power control device 7 using bidirectional communication such as MQTT (Message Queuing Telemetry Transport). Communication unit 803 may also receive demands transmitted from power control device 7 by one-way communication such as by broadcast.

Communication unit 803 receives an index that is transmitted from power control device 7 by one-way communication such as by broadcast. Communication unit 803 may also receive an index that is transmitted from power control device 7 using bidirectional communication such as MQTT.

Communication unit 803 receives operation control information that has been transmitted from power control device 7 using bidirectional communication such as MQTT.

Determination unit 804 determines the usage information according to the demand that was received by communication unit 803.

Control unit 805 controls the charging/discharging operation of storage battery 9 using the usage information that was determined by determination unit 804.

Control unit 805 executes an information acquisition operation (transmission/reception process) of acquiring operation control information from power control device 7 and a control operation (battery operation control process) of using the operation control information to control the charging/discharging operation of storage battery 9.

Control unit 805 repeatedly executes the information acquisition operation with time intervals interposed.

Control unit 805 may also repeatedly execute the control operation with time intervals that are shorter than the time intervals of the information acquisition operation.

For example, detection of the frequency of power system 3 and transmission and reception of indexes are repeatedly executed at period Tᵢ.

The operation time intervals of the control operation need not be fixed.

Apparatus control devices 8, storage batteries 9, and loads 10 are devices that are owned by each consumer. Apparatus control devices 8 and storage batteries 9 may also be owned by a PPS or aggregator that is provided with power control device 7, and may be disposed such that these devices can be used as loads 10 of each consumer. In this case, the PPS or aggregator that is the essential owner of apparatus control devices 8 and storage batteries 9 is able to freely control apparatus control devices 8 and storage batteries 9, but consumers are also able to use apparatus control devices 8 and storage batteries 9 in, for example, the control of loads 10 by forming a predetermined contract.

Power control device 7 is next described.

Power control device 7 has N apparatus control devices 8 and N storage batteries 9 under its control. For example, N apparatus control devices 8 and N storage batteries 9 are maintained by consumers that are supplied with electric power from a PPS. Here, N is an integer equal to or greater than 2. Power control device 7 includes communication unit 701, database 702, comprehension unit 703, and control unit 704. Comprehension unit 703 and control unit 704 are included in generation unit 705.

Communication unit 701 communicates with each apparatus control device 8, load dispatching unit 2, communication unit 111b, and communication unit 112b. For example, Communication unit 701 receives the SOC and ID (Identification) of storage battery 9 from each apparatus control device 8. In addition, communication unit 701 receives information indicating the generation amount of renewable power sources 111 and 112 from communication units 111b and 112b.

Information of each storage battery 9 is stored in database 702.

In addition, storage battery distribution ratio curves that are used for finding the chargeable/dischargeable capacity of storage batteries 9 from the SOC of storage batteries 9 that 5 was received by communication unit 701 are held in database 702. Still further, the rated output P(n) of each storage battery 9 that is used for finding the chargeable/dischargeable capacity is held in database 702. The rated output of a power conditioner (AC/DC converter) (not shown in the figures) that is connected to storage batteries 9 is used for the rated output P(n) of storage batteries 9.

FIGS. 11A and 11B show examples of storage battery distribution ratio curves. FIG. 11A shows an example of storage battery distribution ratio curve 202a during discharge. FIG. 11B shows an example of storage battery distribution ratio curve 202b during charge.

Comprehension unit 703 comprehends the power amount that is borne by N storage batteries 9 (hereinbelow referred to as “DR1 allotted power amount”—“DR2 allotted power amount”) that are under the control of power control device 7 for adjusting the power supply and demand in power system 3 for each of DR applications 1 and 2. Each allotted power amount is an example of the state of the power system.

Comprehension unit 703 comprehends the DR1 allotted power amount as shown below.

Comprehension unit 703 uses the storage battery distribution ratio curves in database 702 to derive the chargeable/dischargeable capacity of a storage battery group that is made up of N storage batteries 9 (hereinbelow referred to as simply “storage battery group”) from the SOC of the N storage batteries 9. The chargeable/dischargeable capacity of a storage battery group is hereinbelow referred to as “total adjustable capacity P_{ES}”.

Comprehension unit 703 transmits total adjustable capacity P_{ES} from communication unit 701 to load dispatching unit 2. Comprehension unit 703 then receives DR1 allotted power amount information that indicates the DR1 allotted power amount in which total adjustable capacity P_{ES} reflected from load dispatching unit 2 by way of communication unit 701. Comprehension unit 703 uses the DR1 allotted power amount information to comprehend the DR1 allotted power amount.

In the present exemplary embodiment, a DR1 charge/discharge gain line is used as the DR1 allotted power amount information. The DR1 charge/discharge gain line indicates LFC assignment capacity LFC_{ES-DR2} that indicates the DR1 maximum allotted power amount and the maximum value (threshold value) Δfₘₐₓ of the integrated value of the frequency deviation (although there are ±Δfₘₐₓ, the ± is hereinbelow omitted for the sake of simplification).

The “maximum value of the integrated value of frequency deviation” is used as the threshold value of the integrated value of the amount of divergence (frequency deviation) with respect to the reference frequency of the system frequency.

Further, the “maximum value of the integrated value of frequency deviation” means the “maximum amount of divergence of the integrated value of frequency deviation” that can be accommodated at total output LFC_{ES-DR1} of N storage batteries 9 that execute DR application 1. When the integrated value of frequency deviation becomes a value equal to or greater than the maximum value (threshold value) of the integrated value of frequency deviation, accommodation by means of LFC_{ES-DR1} becomes problematic.

FIG. 12A shows an example of the DR1 charge/discharge gain line. Details regarding the DR1 charge/discharge gain line will be described later.

The DR1 charge/discharge gain line shows the relation between the integrated value of the frequency deviation and the output of the storage battery group (the total output of N storage batteries 9 that execute DR application 1).

Control unit 704 generates the DR1 allotment information of each storage battery 9 that executes DR application 1 so as to satisfy the relation between the integrated value of frequency deviation and the output of the storage battery group shown by the DR1 charge/discharge gain line. The DR1 allotment information is an example of the first LFC operation control information.

In the present exemplary embodiment, control unit 704 generates the DR1 allotment information (the DR1 allotment coefficient K1 and the maximum value Δfₘₐₓ of the integrated value of the frequency deviation) of each storage battery 9 that executes DR application 1 on the basis of the SOC of the storage batteries 9 that execute DR application 1 and the DR1 charge/discharge gain line. Control unit 704 transmits the DR1 allotment information by way of communication unit 701 to each apparatus control device 8 that executes DR application 1. DR1 allotment coefficient K1 is assumed to be a value that increases as the allotment proportion of the storage batteries 9 that execute DR application 1 rises.

Comprehension unit 703 comprehends the DR2 allotted power amount as shown below.

Comprehension unit 703 uses the storage battery distribution ratio curves in database 702 to derive the chargeable/dischargeable capacity (total adjustable capacity P_{ES}) of the storage battery group. The storage battery distribution ratio curve that is used here is not necessarily the same storage battery distribution ratio curve used when deriving the DR1 allotted power amount.

Comprehension unit 703 transmits total adjustable capacity P_{ES} from communication unit 701 to load dispatching unit 2. Comprehension unit 703 then receives DR2 allotted power amount information indicating the DR2 allotted power amount in which total adjustable capacity P_{ES} is reflected from load dispatching unit 2 by way of communication unit 701. Comprehension unit 703 uses the DR2 allotted power amount information to comprehend the DR2 allotted power amount.

In the present exemplary embodiment, a DR2 charge/discharge gain line is used as the DR2 allotted power amount information. The DR2 charge/discharge gain line indicates the LFC assignment capacity LFC_{ES-DR2} that indicates the DR2 maximum allotted power amount and the maximum value (threshold value) i1ₘₐₓ of the index (although there are ±i1ₘₐₓ, the ± will be omitted hereinbelow in the interest of simplification).

The “maximum value of the index” is used as the threshold value of the index.

In addition, the “maximum value of the index” refers to the “maximum amount of divergence of the index” that can be accommodated at the total output LFC_{ES-DR2} of the N storage batteries 9 that execute DR application 2. When the index becomes a value that is equal to or greater than the maximum value (threshold value) of the index, accommodation by means of LFC_{ES-DR2} becomes problematic.

FIG. 12B shows an example of the DR2 charge/discharge gain line. Details of the DR2 charge/discharge gain line will be described later.

The DR2 charge/discharge gain line indicates the relation between the index and the output of the storage battery group (the total output of the N storage batteries 9 that execute DR application 2).

Control unit 704 generates the DR2 allotment information of each storage battery 9 that executes DR application 2 so as to satisfy the relation between the output of the storage battery group and the index indicated by the DR2 charge/discharge gain line. The DR2 allotment information is an example of the second LFC operation control information.

In the present exemplary embodiment, control unit 704 generates the DR2 allotment information (DR2 allotment coefficient K2 and the maximum value i1ₘₐₓ of the index) of each storage battery 9 that executes DR application 2 on the basis of the SOC of storage batteries 9 that execute DR application 2 and the DR2 charge/discharge gain line. Control unit 704 transmits the DR2 allotment information by way of communication unit 701 to each apparatus control device 8 that executes DR application 2. DR2 allotment coefficient K2 is assumed to be a value that increases in proportion to the level of the allotment percentage of storage batteries 9 that execute DR application 2.

Load dispatching unit 2 is next described.

Load dispatching unit 2 includes frequency meter 201, power flow detection unit 202, communication unit 203, and control unit 204.

Frequency meter 201 detects the frequency of power system 3.

Power flow detection unit 202 detects the power flow in linking line 4.

Communication unit 203 communicates with power control device 7.

For example, communication unit 203 receives total adjustable capacity if from power control device 7. Communication unit 203 further transmits the DR1 charge/discharge gain line and the DR2 charge/discharge gain line to power control device 7.

Control unit 204 controls the operation of load dispatching unit 2.

For example, control unit 204 transmits various demands to power control device 7 by way of communication unit 203.

Control unit 204 further uses the detection result of frequency meter 201 and the detection result of power flow detection unit 202 to generate an index. The method of generating the index is similar to the method described in the modification of the second exemplary embodiment. Control unit 204 transmits the index to power control device 7 by way of communication unit 203. Upon receiving the index by way of communication unit 701 in power control device 7, control unit 204 transmits the index from communication unit 701 to each apparatus control device 8.

Control unit 204 further generates the DR1 charge/discharge gain line and the DR2 charge/discharge gain line as shown below.

The method of generating the DR1 charge/discharge gain line (DR1 allotted power amount information) is first described.

Control unit 204 uses the system frequency that was detected at frequency meter 201 to calculate the Area Requirement (AR) that is an output correction amount of a power plant. Control unit 204 uses the Area Requirement AR, the LFC adjustment capacity of thermal power generator 1 that is the object of control, and total adjustable capacity P_{ES} to derive the LFC capacity. Control unit 204 acquires the LFC adjustment capacity of thermal power generator 1 from the thermal power generator control unit (not shown). Total adjustable capacity P_{ES} is supplied to control runt 204 from communication unit 203.

Control unit 204 assigns to thermal power generator 1, of the LFC capacity, a capacity from which the rapid fluctuation component has been removed. Control unit 204 assigns the remaining LFC capacity LFC_{ES-DR1} (where LFC_{ES-DR1}≦P_{ES}) to the storage battery group. For example, control unit 204 uses a high-pass filter that passes a fluctuation component having a period equal to or less than 10 seconds and that does not pass a fluctuation component having a period longer than 10 seconds to extract, of the LFC capacity, the rapid fluctuation component (capacity LFC_{ES-DR1})) from the LFC capacity.

Control unit 204 otherwise assigns the LFC capacity to thermal power generator 1 and the storage battery group in accordance with the ratio (prescribed value) that has been set in advance.

Control unit 204 treats the capacity LFC_{ES-DR1} as the LFC assignment capacity LFC_{ES-DR1}.

Control unit 204 generates a DR1 charge/discharge gain line (see FIG. 15A) that indicates the LFC assignment capacity LFC_{ES-DR1} and the maximum value (threshold value) Δfₘₐₓ of the integrated value of the frequency deviation that has been set in advance.

Control unit 204 transmits the DR1 charge/discharge gain line to power control device 7 by way of communication unit 202.

The method of generating the DR2 charge/discharge gain line (DR2 allotted power amount information) is next described.

The method of generating the DR2 charge/discharge gain line (DR2 allotted power amount information) is similar to the method of generating the DR1 charge/discharge gain line (DR1 allotted power amount information).

The operation is next described.

(1) The operation by which apparatus control device 8 determines usage information:

FIG. 13 is a flow chart for describing the operation by which apparatus control device 8 determines usage information.

Upon receiving a demand from load dispatching unit 2 (a demand of the power company), control unit 704 in power control device 7 transmits this demand to apparatus control device 8 by way of communication unit 701.

Upon receiving the demand in apparatus control device 8 (Step S1101), communication unit 803 supplies the demand to determination unit 804.

Time slot information that indicates the execution time slot of the DR application that is requested by the demand is appended to each demand.

Determination unit 804, having received the demand, determines, according to the demand, the usage information that is to be used in the DR application that is specified in the demand (Step S1102).

When the demand is a “first LFC demand” in Step S1102, determination unit 804 determines first LFC operation control information and the frequency of power system 3 as the usage information. When the demand is a “second LFC demand”, determination unit 804 determines the second LFC operation control information and the index as the usage information.

Determination unit 804 supplies the determination result of the usage information and the demand (the demand with appended time slot information) to control unit 805.

Upon receiving the determination result of the usage information and the demand, control unit 805 holds the determination result of the usage information and the demand.

(2) The operation of executing DR application 1 (first LFC adjustment process): An outline of the execution operation of DR application 1 is first described.

(2-1) Power control device 7 receives the SOC of N storage batteries 9 from apparatus control devices 8 and thus collects the SOC of N storage batteries 9.

(2-2) Power control device 7 derives total adjustable capacity Pes on the basis of the SOC of N storage batteries 9 with each completion of the reception of SOC of N storage batteries 9.

(2-3) Power control device 7 next transmits the most recent total adjustable capacity P_{ES} to load dispatching unit 2 with each derivation of total adjustable capacity P_{ES}.

(2-4) Load dispatching unit 2 calculates the first LFC assignment capacity LFC_{ES-DR1} (where LFC_{ES-DR1}≦P_{ES}) for the storage battery group for each reception of total adjustable capacity P_{ES}.

(2-5) Load dispatching unit 2 uses the LFC assignment capacity LFC_{ES-DR1} and the maximum value Δfₘₐₓ of the integrated value of the frequency deviation to create the DR1 charge/discharge gain line with each calculation of the first LFC assignment capacity LFC_{ES-DR1}. Load dispatching unit 2 then transmits the DR1 charge/discharge gain line to power control device 7.

(2-6) Power control device 7 calculates DR1 allotment coefficient K1 in accordance with the most recent DR1 charge/discharge gain line that was received from load dispatching unit 2.

(2-7) Power control device 7 next transmits the DR i allotment information (DR1 allotment coefficient K1 and the maximum value Δfₘₐₓ of the integrated value of frequency deviation) to apparatus control devices 8 (for example, processing-object apparatus control devices 8).

(2-8) Each apparatus control device 8 calculates a first local charge/discharge gain line that prescribes the charging/discharging operation of storage batteries 9 on the basis of DR1 allotment coefficient K1 and the maximum value Δfₘₐₓ of the integrated value of frequency deviation. The first local charge/discharge gain line will be described later.

(2-9) Each apparatus control device 8 uses the first local charge/discharge gain line and the frequency of power system 3 to control the charging/discharging operation of storage battery 9.

Details of the operation of executing DR application 1 (the first LFC adjustment process) are next described.

The operation by which power control device 7 derives total adjustable capacity P_{ES} on the basis of the SOC of storage batteries 9 that execute DR application 1 (hereinbelow referred to as the “P_{ES} derivation operation”) is first described.

Information such as the rated output P(n) of storage batteries 9 (the power conditioner output value, the storage battery capacity, the range of usable SOC (for example, a range of from 30% to 90%)) is necessary to derive of total adjustable capacity P_{ES}. These items of information are fundamentally static, and in the present exemplary embodiment, power control device 7 is therefore assumed to have acquired these items of information from each apparatus control device 8 in advance.

FIG. 14 is a sequence diagram for describing the operation of deriving in FIG. 14, the number of apparatus control devices 8 is taken as “1” in the interest of simplifying the explanation.

Communication unit 701 of power control device 2 transmits an information request indicating a request for the SOC to each apparatus control device 8 (Step S1201).

Upon receiving the information request indicating a request for SOC by way of communication unit 803 in each apparatus control device 8, control unit 805 causes detection unit 801 to detect the SOC of storage battery 9 (Step S1202).

Control unit 805 next transmits the SOC that was detected by detection unit 801 together with an ID to power control device 7 by way of communication unit 803 (Step S1203). The ID is hereinbelow described as a sequential number (n) from “1” to “N”.

Power control device 7 waits until the SOC with appended ID (hereinbelow referred to as “SOC(n)”) is received from all N apparatus control devices 8. Power control device 7, having received SOC(n) from all N apparatus control devices 8, derives total adjustable capacity P_{ES} (Step S1204).

Power control device 7 and each apparatus control device 8 repeats the operation of Steps S1201-S1204 (P_{ES} derivation operation).

Step S1204 (derivation of total adjustable capacity P_{ES}) is next described.

Communication unit 701 of power control device 7 repeatedly collects SOC(n) from each apparatus control device 8.

Comprehension unit 703 next uses SOC(n) and storage battery distribution ratio curves 202a and 202b in database 702 to derive storage battery distribution ratio α_{discharge}(n) during discharging and storage battery distribution ratio α_{charge}(n) during charging for each storage battery 9.

In the present exemplary embodiment, curves that change according to information such as the rated output P(n) (output value of a power conditioner and storage battery capacity) of storage battery 9 such as the curves shown in FIGS. 11A and 11B are used as storage battery distribution ratio curves 202a and 202b.

The storage battery distribution ratio curves are not limited to the curves shown above and can be altered as appropriate according to the demand and DR application.

Comprehension unit 703 next uses storage battery distribution ratio α_{discharge} during discharging, storage battery distribution ratio α_{discharge}(n) during charging, the rated output P(n) of each of the total N storage batteries 9 in database 702, and the formulas shown in Numerical Expressions 1 and 2 to derive P_{ES,discharging} discharge and P_{ES,charging}.

$$\begin{matrix}{P}_{ES , discharging} = {\sum }_{n = 1}^{N} {α}_{discharging} ( n ) \cdot P ( n ) & Numerical Expression 1 \\ {P}_{ES , charging} = {\sum }_{n = 1}^{N} {α}_{charging} ( n ) \cdot P ( n ) & Numerical Expression 2\end{matrix}$$

Comprehension unit 703 next adopts, of P_{ES,discharging} and P_{ES,charging}, the smaller value as the total adjustable capacity P_{ES}.

The operation by which the DR1 charge/discharge gain line is comprehended by power control device 7 by communicating with load dispatching unit 2 (hereinbelow referred to as the “DR1 comprehension operation”) is next described.

FIG. 15 is a sequence diagram for describing the DR1 comprehension operation.

Control unit 204 of load dispatching unit 2 uses the system frequency that was detected by frequency meter 201 to calculate the Area Requirement AR (Step S1701).

Control unit 204 next collects the LFC adjustment amount of thermal power generator 1 from the thermal power generator control unit (not shown in the figures) (Step S1702).

On the other hand, communication unit 701 of power control device 7 transmits the most recent total adjustable capacity P_{ES} to load dispatching unit 2 (Step S1703).

Communication unit 203 of load dispatching unit 2 receives the most recent total adjustable capacity P_{ES} that was transmitted from communication unit 701 of power control device 7. Communication unit 203 supplies this most recent total adjustable capacity P_{ES} to control unit 204.

Control unit 204, upon receiving the most recent total adjustable capacity P_{ES}, uses the Area Requirement AR, the LFC adjustment capacity of thermal power generator 1, and the most recent total adjustable capacity P_{ES} to derive the LFC capacity. Control unit 204 next assigns to thermal power generator 1, of the LFC capacity, a capacity from which the rapid fluctuation component has been removed. Control unit 204 then assigns to the storage battery group that executes DR application 1 the remaining LFC capacity LFC_{ES-DR1} (where LFC_{ES-DR1}≦P_{ES}) as the LFC assignment capacity LFC_{ES-DR1} (Step S1704).

Control unit 204 determines the ratio of the assignment of the LFC capacity to thermal power generator 1 and LFC assignment capacity LFC_{ES-DR1}, giving consideration to economy while considering the accepted portion of the EDC (Economic load Dispatching Control) component.

Control unit then generates a DR1 charge/discharge gain line (see FIG. 12A) that indicates the LFC assignment capacity LFC_{ES-DR1} and the maximum value Δfₘₐₓ of the integrated value of frequency deviation that was determined in advance (Step S1705)

The DR1 charge/discharge gain line shown in FIG. 12A shows the amount of charging/discharging of the storage battery group (storage batteries 9 that execute DR application 1) with respect to the integrated value Δf of the frequency deviation. The DR1 charge/discharge gain line changes, becoming line 400A and line 400B according to the magnitude of the LFC assignment capacity LFC_{ES-DR1} (LFC_{ES-DR1} and LFC_{ES-DR1}′) in the range in which “LFC assignment capacity LFC_{ES-DR1}≦total adjustable capacity P_{ES}”.

Control unit 204 next transmits the DR1 charge/discharge gain line from communication unit 203 to power control device 7 (Step S1706).

Power control device 7 and load dispatching unit 2 repeat the operations of Steps S1701- S1706 (the DR1 comprehension operation).

Comprehension unit 703 of power control device 7 receives the DR1 charge/discharge gain line by way of communication unit 701 and holds the most recent charge/discharge gain line.

The operations of generating DR1 allotment information, transmitting the DR1 allotment information to each apparatus control device 8, and of each apparatus control device 8 deriving a local charge/discharge gain line for controlling the operation of storage battery 9 on the basis of the DR1 allotment information (hereinbelow referred to as the “DR1 allotment operation”) are next described.

FIG. 16 is a sequence diagram for describing the DR1 allotment operation. In FIG. 16, the number of apparatus control devices 8 that execute DR application 1 is made “1” in the interest of simplifying the explanation.

Control unit 704 of power control device 7 uses the LFC assignment capacity LFC_{ES-DR1} indicated in the most recent charge/discharge gain line, the most recent total adjustable capacity P_{ES}, and the formula shown in Numerical Expression 3 to derive DR1 allotment coefficient K1 (Step S1801).

$$K 1 = \frac{{LFC}_{ES \cdot DR 1}}{{P}_{ES}} \qquad Numerical Expression 3$$

Control unit 704 next transmits the DR1 allotment information, that indicates DR1 allotment coefficient K1 and the maximum value Δfₘₐₓ of the integrated value of frequency deviation that was indicated by the most recent DR1 charge/discharge gain line, to apparatus control devices 8 that execute DR application 1 by way of communication unit 701 (Step S1802). DR1 allotment coefficient K1 is not limited to the value specified in Numerical Expression 3. For example, during times of stringent power supply and demand, a value (such as 0.97) that indicates forced output that approaches the limit may be used as DR1 allotment coefficient K1. The value that indicates output that approaches the limit is not limited to 0.97 and can be altered as appropriate.

In the present exemplary embodiment, the following process is carried out in Step S1802.

For each storage battery 9 that executes DR application 1 (storage battery 9 for which SOC was received), control unit 704 specifies, as the storage battery distribution ratio α(n), the smaller value of the most recent storage battery distribution ratio α_{discharge}(n) during discharging and storage battery distribution ratio α_{charging}(n) during charging that were derived by comprehension unit 703.

Control unit 704 next generates for each storage battery 9 that executes DR application 1 (storage battery 9 for which SOC was received) operation-relevant information that shows storage battery distribution ratio α(n) and the rated output P(n) that is being held in database 702.

Control unit 704 next appends the DR1 allotment information to each item of operation-relevant information.

Control unit 704 then transmits by way of communication unit 701 the DR1 allotment information to which the operation-relevant information has been appended to apparatus control devices 8 that correspond to the operation-relevant information. The DR1 allotment information to which the operation-relevant information has been appended is an example of the first LFC operation control information.

In apparatus control device 8 that executes DR application 1, control unit 805 receives the DR1 allotment information to which operation-relevant information has been appended by way of communication unit 803.

Control unit 805 uses the DR1 allotment information to which the operation-relevant information has been appended and the formula shown in Numerical Expression 4 to derive a local charge/discharge gain coefficient G1(n) (Step S1803).

$$G 1 ( n ) = \frac{K 1 \cdot α ( n ) \cdot P ( n )}{Δ {f}_{ma x}} \qquad Numerical Expression 4$$

The values in the formula of Numerical Expression 4 are indicated in the DR1 allotment information to which operation-relevant information has been appended.

Control unit 805 next uses the local charge/discharge gain coefficient G1(n) and the maximum value Δfₘₐₓ of the integrated value of frequency deviation that is indicated in the DR1 allotment information with appended operation-relevant information to derive first local charge/discharge gain line 800A shown in FIG. 17 (Step S1804).

First local charge/discharge gain line 800A shown in FIG. 17 passes through the origin 0 with an inclination that is the value of local charge/discharge gain coefficient G1(n) in the region in which the integrated value Δf of the frequency deviation is −Δfₘₐₓ≦Δf≦Δfₘₐₓ. Further, first local charge/discharge gain line 800A is a fixed value of “−K1·α(n)·P(n)” (where the minus sign indicates discharging) in the range in which the integrated value Δf of the frequency deviation is Δf<−Δfₘₐₓ. In addition, first local charge/discharge gain line 800A is a fixed value of “K1·α(n)·P(n)” in She range in which integrated value Δf of the frequency deviation is Δfₘₐₓ<Δf.

Power control device 7 and each apparatus control device 8 that executes DR application 1 repeats the process of Steps S1801-S1804.

In each apparatus control device 8 that executes DR application 1, control unit 805 receives DR1 allotment information with appended operation-relevant information by way of communication unit 803 and holds the most recent DR1 allotment information with appended operation-relevant information.

The operation by which apparatus control device 8 that executes DR application 1 controls charging/discharging of storage battery 9 on the basis of the DR1 allotment information with appended operation-relevant information and the system frequency (hereinbelow referred to as the “DR1 charging/discharging control operation”) is next described.

With the arrival of the start time of DR application 1 that is indicated in time slot information, control unit 704 of power control device 7 transmits to apparatus control device 8 that executes DR application 1 DR1 execution interval information that indicates operation period T2-A. Operation period T2-A is, for example, 1 second. Control unit 805 of apparatus control device 8 that is to execute DR application 1, upon receiving the DR1 execution interval information by way of communication unit 803, holds the DR1 execution interval information.

FIG. 18 is a sequence diagram for describing the charging/discharging control operation.

In apparatus control device 8 that executes DR application 1, control unit 805 causes detection unit 802 to detect the system frequency (Step S2001).

Control unit 805 next calculates the integrated value Δf of the frequency deviation by subtracting the reference frequency (50 Hz) of the system frequency from the detection result of detection unit 802 and integrating the result of subtraction (Step S2002).

Control unit 805 next calculates the charging amount or discharging amount of storage battery 9 that executes DR application 1 in accordance with the integrated value Δf of the frequency deviation and the local charge/discharge gain line (Step S2003).

If the absolute value of the integrated value Δf of the frequency deviation is equal to or less than the maximum-value (threshold value) Δfₘₐₓ of the integrated value of the frequency deviation in Step S2003, control unit 805 calculates the absolute value of the value obtained by multiplying the local charge/discharge gain coefficient G1(n) by the integrated value Δf of the frequency deviation (G1(n)·Δf) as the adjustment amount.

On the other hand, if the absolute value of the integrated value Δf of the frequency deviation is greater than the maximum value of the integrated value of the frequency deviation, control unit 805 calculates the value obtained by multiplying together allotment coefficient K1, storage battery distribution ratio α(n), and rated output P(n) (K1·α(n)·P(n)) as the adjustment amount.

Here, an example of point symmetry was shown in which the inclination of G1(n) is identical on the charging side and discharging side in FIG. 17, but in actuality, a case that is not point symmetry can also be supposed. In such a case as well, G1(n) is determined by the same approach as shown above.

When the integrated value Δf of the frequency deviation is a positive value, control unit to 805 next causes storage battery 9 that executes DR application 1 to execute a charging operation by the amount of the adjustment amount. Alternatively, if the integrated value Δf of the frequency deviation is a negative value, control unit 805 causes storage battery 9 that executes DR application 1 to execute a discharging operation of the adjustment amount (Step S2004). Each apparatus control device 8 repeats the processes of Steps S2001-S2004 at period T2-A that is indicated in the DR1 execution interval information. As a result, the value of the integrated value of the frequency deviation changes each time, and charging/discharging is implemented each time according to G1(n)·Δf.

As a result, the integrated value of the frequency deviation changes each time at period T2-A(=1 second), but the charging/discharging operation of storage battery 9 is carried out using the same DR1 allotment information until the DR1 allotment information is updated.

(3) The operation of executing DR application 2 (Second LFC adjustment process):

An outline of the operation of executing DR application 2 is first described.

(3-1) Power control device 7 receives from apparatus control devices 8 the SOC of N storage batteries 9 and collects the SOC of the N storage batteries 9.

(3-2) Power control device 7 derives total adjustable capacity if s on the basis of the SOC of N storage batteries 9 with each completion of the reception of the SOC of N storage batteries 9.

(3-3) Each time that total adjustable capacity P_{ES} is derived, power control device 7 next transmits the most recent total adjustable capacity P_{ES} to load dispatching unit 2.

(3-4) Each time that total adjustable capacity P_{ES} is received, load dispatching unit 2 calculates LFC assignment capacity LFC_{ES-DR2} (where LFC_{ES-DR2}≦P_{ES}) for the storage battery group.

(3-5) With each calculation of LFC assignment capacity LFC_{ES-DR2}, load dispatching unit 2 uses maximum value i1ₘₐₓ of an index that is the integrated value of the corrected frequency deviation in which the frequency deviation is corrected by the power flow of linking line 4 and LFC assignment capacity LFC_{ES-DR2} to create a DR2 charge/discharge gain line. Load dispatching unit 2 then transmits the DR2 charge/discharge gain line to power control device 7.

(3-6) Power control device 7 calculates DR2 allotment coefficient K2 in accordance with the most recent DR2 charge/discharge gain line that was received from load dispatching unit 2.

(3-7) Power control device 7 next transmits the DR2 allotment information (DR2 allotment coefficient K2 and the maximum value i1ₘₐₓ of the index) to apparatus control devices 8 (for example, processing-object apparatus control devices 8).

(3-8) Each apparatus control device 8 calculates a second local charge/discharge gain line that prescribes the charging/discharging operation of storage batteries 9 on the basis of DR2 allotment coefficient K2 and the maximum value i1ₘₐₓ of the index. The second local charge/discharge gain line will be described later.

(3-9) Each apparatus control device 8 uses the second local charge/discharge gain line and received index to control the charging/discharging operation of storage battery 9.

Details of the operation of executing DR application 2 (second LFC adjustment process) are next described.

The operation by which power control device 7 derives total adjustable capacity P_{ES} on the basis of the SOC of storage batteries 9 that execute DR application 2 is first described.

This P_{ES} derivation operation can be described by substitution in the above-described P_{ES} derivation operation of DR application 1 as shown below:

“DR application 1” is replaced by “DR application 2”.

The operation by which power control device 7 communicates with load dispatching unit 2 to comprehend the DR2 charge/discharge gain line (hereinbelow referred to as the “DR2 comprehension operation) is next described.

FIG. 19 is a sequence diagram for describing the DR2 comprehension operation.

Control unit 204 of load dispatching unit 2 uses the system frequency that was detected by frequency meter 201 and the power flow in linking line 4 that was detected by power flow detection unit 202 to calculate Area Requirement AR-1 (Step S2101).

Control unit 205 next collects the LFC adjustment capacity of thermal power generator 1 from thermal power generator control unit (not shown) (Step S2102).

On the other hand, communication unit 701 of power control device 7 transmits the most recent total adjustable capacity P_{ES} to load dispatching unit 2 (Step S2103).

Communication unit 203 of load dispatching unit 2 receives the most recent total adjustable capacity P_{ES} that was transmitted from communication unit 701 of power control device 7. Communication unit 203 supplies this most recent total adjustable capacity P_{ES} to control unit 204.

Control unit 204, upon receiving the most recent total adjustable capacity P_{ES} uses the Area Requirement AR-1, the LFC adjustment capacity of thermal power generator 1, and the most recent total adjustable capacity P_{ES} to derive the LFC capacity. Control unit 204 next assigns to thermal power generator 1, of the LFC capacity, a capacity from which the rapid fluctuation component has been removed. Control unit 204 then assigns the remaining LFC capacity LFC_{ES-DR2} (where LFC_{ES-DR2}≦P_{ES}) to the storage battery group that executes DR application 2 as LFC assignment capacity LFC_{ES-DR2} (Step S2104).

Control unit 204 determines the ratio of assignment of LFC capacity to thermal power generator 1 and the LFC assignment capacity LFC_{ES-DR2} gives consideration to economy while considering the accepted portion of the EDC component.

Control unit 204 then generates DR2 charge/discharge gain line (see FIG. 12B) that indicates the LFC assignment capacity LFC_{ES-DR2} and the maximum value i1ₘₐₓ of the index that has been set in advance (Step S2105).

The DR2 charge/discharge gain line shown in FIG. 12B shows the charging/discharging amount of the storage battery group (storage batteries 9 that execute DR application 2) with respect to the index. The DR2 charge/discharge gain line changes, becoming line 400C and line 400D according to the magnitude of LFC assignment capacity LFC_{ES-DR2} (LFC_{ES-DR2} and LFC_{ES-DR2}′) in the range in which “LFC assignment capacity LFC_{ES-DR2}≦total adjustable capacity P_{ES}”.

Control unit 204 next transmits the DR2 charge/discharge gain line from communication unit 203 to power control device 7 (Step S2106).

Power control device 7 and load dispatching unit 2 repeat the operation of Steps S2101- S2106 (the DR2 comprehension operation).

Comprehension unit 703 of power control device 7 receives the DR2 charge/discharge gain line by way of communication unit 701 and holds the most recent DR2 charge/discharge gain line.

The operation of the generation of DR2 allotment information, the transmission of the DR2 allotment information to each apparatus control device 8, and the derivation by each apparatus control device 8 of a second local charge/discharge gain line for controlling the operation of storage battery 9 on the basis of the DR2 allotment information (hereinbelow referred to as the “DR2 allotment operation”) is next described.

FIG. 20 is a sequence diagram for describing the DR2 allotment operation. In FIG. 20 the number of apparatus control devices 8 that execute DR application 2 is made “1” in the interest of simplifying the explanation.

Control unit 704 of power control device 7 uses the LFC assignment capacity LFC_{ES-DR2} that is indicated in the most recent DR2 charge/discharge gain line, the most recent total adjustable capacity P_{ES}, and the formula shown in Numerical Expression 5 to derive DR2 allotment coefficient K2 (Step S2201).

$$K 2 = \frac{{LFC}_{ES \cdot DR 2}}{{P}_{ES}} \qquad Numerical Expression 5$$

Control unit 704 next transmits DR2 allotment information that indicates DR2 allotment coefficient K2 and maximum value i1ₘₐₓ of the index indicated in the most recent DR2 charge/discharge gain line by way of communication unit 701 to each apparatus control device 8 that executes DR application 2 (Step S2202). DR2 allotment coefficient R2 is not limited to the value specified in Numerical Expression 5. For example, at times of stringent power supply and demand, a value (such as 0.97) indicating forced output that approaches the limit may be used as DR2 allotment coefficient K2. The value that indicates output close to the limit is not limited to 0.97 and can be altered as appropriate.

Here, control unit 704 does not execute the process of Step S2202 for apparatus control devices 8 that correspond to storage batteries 9 for winch the SOC was not received.

In the present exemplary embodiment, the following process is executed in Step S2202.

For each storage battery 9 that executes DR application 2, control unit 704 specifies as storage battery distribution ratio α(n) the smaller value of the most recent storage battery distribution ratio α_{discharge}(n) during discharging and storage battery distribution ratio α_{charge}(n) during charging that were derived by comprehension unit 703.

Control unit 704 next generates operation-relevant information that shows, for each storage battery 9 that executes DR application 2 storage battery distribution ratio α(n) and the rated output P(n) that is being held in database 702.

Control unit 704 next adds DR2 allotment information to each item of operation-relevant information.

Control unit 704 then transmits by way of communication unit 701 the DR2 allotment information to which the operation-relevant information has been appended to apparatus control devices 8 that correspond to the operation-relevant information. The DR2 allotment a information to which the operation-relevant information has been appended is an example of the second LFC operation control information.

In each apparatus control device 8 that executes DR application 2, control unit 805 receives the DR2 allotment information to which the operation-relevant information has been appended by way of communication unit 803.

Control unit 805 uses the DR2 allotment information to which the operation-relevant information has been appended and the formula shown in Numerical Expression 6 to derive the local charge/discharge gain coefficient G2(n) (Step S2203).

$$G 2 ( n ) = \frac{K 2 \cdot α ( n ) \cdot P ( n )}{i 1 max} \qquad Numerical Expression 6$$

The values in the formula of Numerical Expression 6 are indicated in the DR2 allotment information to which the operation-relevant information has been appended.

Control unit next uses local charge/discharge gain coefficient G2(n) and the maximum value i1ₘₐₓ of the index that is indicated in the DR2 allotment information with appended operation-relevant information to derive second local charge/discharge gain line 800B shown in FIG. 21 (Step S2204).

Second local charge/discharge gain line 800B shown in FIG. 21 is a straight line that passes through the origin 0 with an inclination that is the local charge/discharge gain coefficient G2(n) in the range in which the index is −i1ₘₐₓ≦index≦i1ₘₐₓ. In addition, second local charge/discharge gain line 800B is a fixed value of “−K2·α(n)·P(n)” (where the minus sign indicates discharging) in the range in which the index is: index <−i1ₘₐₓ. Second local charge/discharge gain line 800B is further a fixed value “K2·α(n)·P(n)” in the range in which the index is: i1ₘₐₓ< index.

Power control device 7 and each apparatus control device 8 that executes DR application 2 repeats the processes of Steps S2201-S2204.

In each apparatus control device 8 that executes DR application 2, control unit 805 receives DR2 allotment information with appended operation-relevant information by way of communication unit 803 and holds the most recent DR2 allotment information with appended operation-relevant information.

The operation by which apparatus control device 8 that executes DR application 2 controls the charging/discharging of storage battery 9 on the basis of DR2 allotment information with appended operation-relevant information and an index (hereinbelow referred to as the “DR2 charging/discharging control operation”) is next described.

Upon the arrival of the start time of DR application 2 that is indicated in the time slot information, control unit 704 of power control device 7 transmits DR2 execution interval information that indicates operation period T3_{SecondLFC} to apparatus control devices 8 that execute DR application 2 by way of communication unit 701. Operation period T3_{SecondLFC} is, for example, 1 second. Control unit 805 of apparatus control device 8 that executes DR application 2, upon receiving the DR2 execution interval information by way of communication 803, holds the DR2 execution interval information.

FIG. 22 is a sequence diagram for describing the charging/discharging control operation.

Apparatus control device 8 that executes DR application 2 receives an index that was transmitted from power control device 7 by way of communication unit 803 (Step S2401).

Control unit 805 then calculates the charging amount or discharging amount of storage battery 9 that executes DR application 2 in accordance with the second local charge/discharge gain line and the index that was received by way of communication unit 803 (Step S2402).

When the absolute value of the index is equal to or less than the maximum value (threshold value) i1ₘₐₓ of the index in Step S2402, control unit 805 calculates the absolute value of the value obtained by multiplying local charge/discharge gain coefficient G2(n) by the index (G2(n)·index) as the adjustment power amount.

On the other hand, when the absolute value of the index is greater than the maximum value i1ₘₐₓ of the index, control unit 805 calculates a value obtained by multiplying together allotment coefficient K2, storage battery distribution ratio α(n), and the rated output P(n)(K2·α(n)·P(n)) as the adjustment power amount

Although a case of point symmetry in which the inclination of G2(n) is the same on the charging side and discharging side is shown in FIG. 21, in actuality, a case that is not point symmetry can also be supposed. In such a case, G2(n) is determined by the same approach as shown above.

Control unit 805 next causes storage battery 9 that executes DR application 2 to execute a charging operation of the adjustment power amount when the index is a positive value. Alternatively, control unit 805 causes storage battery 9 that executes DR application 2 to execute a discharging operation of the adjustment power amount when the index is a negative value (Step S2403).

Each apparatus control device 8 repeats the processes of Steps S2401-S2403 at period T3_{SecondLFC} that is indicated in the DR2 execution interval information. As a result, the value of the index changes each time, and with each execution, charging/discharging is implemented according to “G2(n)·index”.

In the present exemplary embodiment, an example was shown in which an index was derived, but the index is not limited by the derivation method shown in the present exemplary embodiment, and an index that is derived by load dispatching unit by a different method can also be used. For example, an index can be considered that is similar to LFC signals that are distributed by PJM, which is a U.S. ISO (Independent System Operator).

Essentially, the index changes with each period T3_{SecondLFC}, but the charging/discharging operation of storage battery 9 is carried out using the same DR2 allotment information until the DR2 allotment information is updated.

The effect of the present exemplary embodiment is next described.

According to the present exemplary embodiment, at the time that accords with the completion of reception of the SOC of N storage batteries 9, generation unit 705 generates DR1 allotment information with appended operation-relevant information of each of N storage batteries 9 on the basis of the SOC. Communication unit 701 then transmits the corresponding DR1 allotment information with appended operation-relevant information to apparatus control devices 8 that correspond to each storage battery 9.

As a result, even when reception of the SOC of N storage batteries 9 cannot be realized within a fixed time interval, the DR1 allotment information with appended operation-relevant information of each of N storage batteries 9 can be generated and transmitted. As a result, power supply/demand adjustment that uses storage batteries that are under control can be executed with good accuracy.

For example, even when variation occurs in the transmission times of the SOC of N storage batteries 9, the DR1 allotment information with appended operation-relevant information of N storage batteries 9 can be generated and transmitted.

The present exemplary embodiment and a comparative example are next compared.

FIG. 23 shows the third exemplary embodiment and a comparative example. FIG. 23(a) corresponds to the comparative example, and FIG. 23(b) corresponds to the third exemplary embodiment.

FIG. 23 shows portions relating to the transmission of the SOC of storage battery 9 and the transmission of DR1 allotment information with appended operation-relevant information. In the following explanation, “DR1 allotment information with appended operation-relevant information” is referred to as “operation control information”.

In FIGS. 23(a) and (b), the number of apparatus control devices 8 is “4”, and the four apparatus control devices 8 are shown as apparatus control devices 81-84. In FIGS. 23(a) and (b), moreover, the operation of power control device 7 at transmission times 500-1-500-4 is shown as the comparative example, and the operation of power control device 7 at transmission times 500-1-500-3 is shown as the third exemplary embodiment. In FIGS. 23(a) and (b), moreover, the same reference numbers are applied in the comparative example as in the third exemplary embodiment for the purpose of simplifying the explanation.

The comparative example shown in FIG. 23(a) is first described.

Apparatus control devices 81-84 each transmit SOC 81b-84b, respectively, of corresponding storage batteries 9 to power control device 7 at fixed period T1_{FirstLFC} (for example, 15 minutes).

Power control device 7, when having received the SOC of storage batteries 9 from all apparatus control devices 81-84 during period T1_{FirstLFC}, transmits operation control information 81a-84a that accords with the SOC of storage batteries 9 to apparatus control devices 81-84. Power control device 7 executes the process of transmitting operation control information at period T1_{FirstLFC}.

Apparatus control devices 81-84 control the charging/discharging of corresponding storage batteries 9 at period T2-A on the basis of operation control information 81a-84a that was received from power control device 7 at period T1_{FirstLFC} and the system frequency (integrated value of frequency deviation) that was acquired at period T2-A (for example, 1 second). For example, in interval 505-1, the following operations are executed.

Apparatus control devices 81-84 each transmit SOC 81b-1-84b-1 of corresponding storage batteries 9 to power control device 7.

Power control device 7, upon receiving SOC 81b-1-84b-1 of storage batteries 9 from apparatus control devices 81-84, transmits operation control information 81a-2-84a-2 that correspond to the SOC of each of storage batteries 9 to apparatus control devices 81-84.

In interval 505-2 that continues after interval 505-1, apparatus control devices 81-84 control the charging/discharging of each of corresponding storage batteries 9 at period T2-A on the basis of operation control information 81a-2-84a-2 and the system frequency (integrated value of the frequency deviation) that is acquired at period T2-A.

However, in this comparative example, when unable to receive the SOC of storage batteries 9 from at least any one of apparatus control devices 81-84 daring period T1_{FirstLFC}, power control device 7 does not execute the generation process and distribution process of operation control information.

Further, the inability of power control device 7 to receive the SOC of storage batteries 9 from at least any one of apparatus control devices 81-84 during period T1_{FirstLFC} is thought to arise due to, for example, communication time differences that arise due to differences in congestion of the communication paths between power control device 7 and apparatus control devices 81-84 or differences in response time that arise due to differences of the processing load of apparatus control devices 81-84.

As a result, when a state in which the SOC of storage batteries 9 cannot be received from at least any one of apparatus control devices 81-84 occurs continuously, the updating of some operation control information becomes impossible. The problem therefore arises that power supply/demand adjustment cannot be realized with good accuracy.

On the other hand, in the third exemplary embodiment (see FIG. 23(b)), power control device 7 generates and transmits operation control information of each storage battery 9 with each completion of the reception of the SOC of storage batteries 9.

As a result, the transmission interval of operation control information (intervals 506-1 and 506-2) changes dynamically as shown in FIG. 23(b).

A modification of the present exemplary embodiment is next described.

In the present exemplary embodiment, an example is shown in which generation unit 705 waits until the SOC is received from all N apparatus control devices 8.

However, generation unit 705 may also, at the time of the reception of the SOC from, of N apparatus control devices 8, a predetermined percentage (for example, 70% of the entirety) of apparatus control devices 8, set (generate) the operation control information of storage batteries in that predetermined percentage of apparatus control devices 8 on the basis of that SOC. The predetermined percentage is not limited to 70% and can be altered as appropriate.

In this case, generation unit 705 determines the SOC that was received from the predetermined percentage of apparatus control devices 8 as the SOC of the processing-object storage batteries 9. Generation unit 705 then uses, as the SOC of the remaining storage batteries 9 (non-processing-object storage batteries 9), the most recent SOC among the SOC of non-processing-object storage batteries 9 that was received in the past. By carrying out this operation, generation unit 705 recognizes the SOC of all storage batteries 9.

Generation unit 705 subsequently sets (generates) the operation control information of N storage batteries 9 as shown above and transmits the operation control information of storage batteries 9 in the predetermined percentage of apparatus control devices 8 to the predetermined percentage of apparatus control devices 8 by way of communication unit 701.

In this case, in apparatus control devices 8 that did not transmit the SOC or that transmitted the SOC but for which the SOC did not reach power control device 7, control unit 805 controls the operation of storage batteries R2 at period T2-A or period T3_{SecondLFC} on the basis of past operation control information that was being held in control unit 805 and the integrated value of the frequency deviation or an index. In this case, the circumstances for apparatus control device 8 not transmitting the SOC include circumstances in which apparatus control device 8 intentionally did not transmit the SOC and circumstances in which, against all intentions, the SOC was not (could not) be transmitted due to, for example, the occurrence of a communication problem.

In addition, when, at the time of receiving the SOC from a predetermined percentage (for example, 70% of the entirety) of apparatus control devices 8 of N apparatus control devices 8, generation unit 705 sets (generates) operation control information of storage batteries in the predetermined percentage of apparatus control devices 8 on the basis of these SOC, generation unit 705 may also operate as shown below.

Generation unit 705 uses the SOC of processing-object storage batteries 9 without using the SOC of non-processing-object storage batteries 9 to generate the operation control information of these storage batteries 9.

In this case, generation unit 705 determines that storage batteries 9 that should have been the original N storage batteries 9 have changed to the number “N-a” of the predetermined percentage and executes the above-described operation that was to be carried out by N storage batteries 9 with the storage batteries.

As another modification, a configuration may be used in which only DR application 1 or DR application 2 is executed. When DR application 2 is executed and DR application 1 is not executed, detection unit 801 may be omitted.

The power supply/demand adjustment process is not limited to LFC and can be altered as appropriate. For example, a peak-cutting process of executing power peak cutting or a GF (Governor Free) adjustment process may also be used. For example, when a GF adjustment process is adopted, “frequency deviation” should be used in place of the above-described “index” or “integrated value of the frequency deviation”.

When discharging (reverse power flow) from storage battery 9 (consumer side) to power system 3 is prohibited, control unit 805 causes the discharging power of storage battery 9 to be discharged within the range of the power consumption amount of load 10 of the consumer. Causing the discharged power of storage battery 9 to be consumed by load 10 reduces the demand for power upon power system 3.

When the discharging (reverse power flow) from storage battery 9 (consumer side) to power system 3 is not prohibited, control unit 805 may supply the discharged power of storage battery 9 to power system 3.

In the above-described exemplary embodiments, control devices A and C, apparatus control devices D1 and 8, and power control device 7 may each be realized by a computer. In such cases, a computer executes the functions of control devices A or C, apparatus control devices D1 or 8, or power control device 7 by reading and executing a program that is recorded on a recording medium that can be read by the computer. The recording medium is, for example, a CD-ROM (Compact Disk Read Only Memory). The recording medium is not limited to a CD-ROM and can be altered as appropriate.

In each of the above-described exemplary embodiments, the configurations shown in the figures are merely examples, and the present invention is not limited to these configurations.

In addition, although the invention of the present application has been described with reference to exemplary embodiments, the invention of the present application is not limited to the above-described exemplary embodiments. The configuration and details of the invention of the present application are open to various modifications within the scope of the invention of the present application that will be clear to one of ordinary skill in the art.

This application claims the benefits of priority based on Japanese Patent Application No. 2015-068857 for which application was submitted on Mar. 30, 2015 and incorporates by citation all of the disclosures of that application.

### EXPLANATION OF THE REFERENCE NUMBERS

A, C control device
   A1, C1 generation unit
A2 transmission unit
C2 communication unit
D power supply/demand adjustment device
D1 apparatus control device
D1a communication unit
D1b detection unit
D1c control unit
R1 power system

R2 storage battery
R3 linking line
R4 another power system
1000 power control system
1 thermal power generator
2 load dispatching unit
201 frequency meter
202 power flow detection unit
203 communication unit
204 control unit
3 power system
4 linking line
5 distribution transformer
6 power line
7 power control device
701 communication unit
702 database
703 comprehension unit
704 control unit
705 generation unit
8 apparatus control device
801, 802 detection unit
803 communication unit
804 determination unit
805 control unit
9 storage battery
10 load
111 renewable power source (photovoltaic power generator;
112 renewable power source (wind power generator)

1. A control device comprising:
a setting unit that, at the time of receiving status information that relates to a plurality of power supply/demand adjustment devices, sets operation control information of each of said plurality of power supply/demand adjustment devices on the basis of said status information; and
a transmission unit that transmits said operation control information to correspond to said power supply/demand adjustment devices.

2. The control device according to claim 1, wherein said setting unit sets said operation control information each time status information is received from a predetermined number of power supply/demand adjustment devices.

3. The control device according to claim 2, wherein said setting unit, in accordance with the time of receiving status information that relates to said plurality of power supply/demand adjustment devices, controls the time intervals between the time of setting said operation control information and the time of setting said operation control information in accordance with a previous reception.

4. The control device according to claim 3, wherein said setting unit lengthens said time intervals in proportion to the increase of the length of the time of receiving status information that relates to said plurality of power supply/demand adjustment devices.

5. The control device according to claim 1, wherein said operation control information specifies the relation between the operation of said corresponding power supply/demand adjustment devices and adjustment amount information that relates to power supply/demand adjustment amount.

6. The control device according to claim 5, wherein said setting unit generates said operation control information at a period that is longer than the acquisition period of said adjustment amount information in said power supply/demand adjustment devices.

7. The control device according to claim 6, wherein said transmission unit transmits said operation control information to said corresponding power supply/demand adjustment devices each time said setting unit sets said operation control information.

8. An apparatus control device that controls the operation of a supply/demand adjustment device that is connected to a power system, comprising:
detection means that detects a state of said supply/demand adjustment device;
communication means that transmits the detection result of said detection means to an outside device and that receives from the outside device operation control information that controls the operation of said supply/demand adjustment device; and
control means that replaces operation control information that is being held with operation control information that was received by said communication means and, on the basis of said operation control information that follows replacement, controls the operation of said supply/demand adjustment device.

9. The apparatus control device according to claim 8, further comprising:
reception means that receives an index that relates to an adjustment power amount that is transmitted by means of bidirectional communication or one-way communication;
wherein said control means controls the operation of said supply/demand adjustment device on the basis of said operation control information that follows replacement and said index.

10. The apparatus control device according to claim 8, further comprising:
a detection unit that detects a state of the power system;
wherein said control means controls the operation of said supply/demand adjustment device on the basis of said operation control information that follows replacement and the state of said power system.

11. The apparatus control device according to claim 9, wherein, when said operation control information is not received in a predetermined interval, said control means controls the operation of said supply/demand adjustment device on the basis of said operation control information that is being held and on the basis of said index.

12. The apparatus control device according to claim 9, wherein said communication means receives said index at an interval that is shorter than the interval of receiving said operation control information, and receives said index and said operation control information at each predetermined interval.

13. The apparatus control device according to claim 10, wherein, when said operation control information is not received in a predetermined interval, said control means controls the operation of said supply/demand adjustment device on the basis of said operation control information that is being held and on the basis of the state of said power system.

14. A control system that includes a first control device that controls the operation of a power supply/demand adjustment device that is connected to a power system and a second control device that communicates with said first control device, wherein:
said first control device includes:
a detection unit that detects a state relating to said power supply/demand adjustment device;
a communication unit that transmits status information that indicates the slate relating to said power supply/demand adjustment device that was detected by said detection unit to said second control device and that receives from said second control device operation control information that controls the operation of said power supply/demand adjustment device; and
a control unit that replaces operation control information that is being held with operation control information that was received by said communication unit and that controls the operation of said power supply/demand adjustment device on the basis of said operation control information; and
said second control device includes:
a setting unit that, at the time of receiving status information that relates to a plurality of said power supply/demand adjustment devices, sets operation control information of each of said plurality of power supply/demand adjustment devices on the basis of said status information, and
a transmission unit that transmits said operation control information to correspond to said power supply/demand adjustment devices.

15.-18. (canceled)
